(19) United States
(12) Patent Application Publication
(10) Pub. No.: US 2004/0111308 A1
(43) Pub. Date: Jun. 10, 2004

(54) Dynamic resource allocation platform and method for time related resources

(75) Inventor: Yaron Yakov, Lapid (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Brighthaul Ltd.

(21) Appl. No.: 10/314,198

(22) Filed: Dec. 9, 2002

(51) Int. Cl. G06F 17/60; G06F 15/173; G06F 17/00

(52) U.S. Cl. 705/8; 709/226; 706/909; 705/1; 705/400

(57) ABSTRACT

A resource allocation platform for allocating resources between a provider and a plurality of users at a certain price differentiated for different users, the resources being time dependent resources such as communication data capacity, the platform comprising: an agent-based interaction mechanism for allowing said provider and said plurality of users to indicate their requirements and to translate the requirements into offers and bids, and a pricing engine for ascertaining a resource allocation price for the offers and bids. The pricing engine uses a learning mechanism for learning demand behavior of individual users so that it can translate their requirements into a price which is fair to them and fair to the provider. Thus, the time-consuming, and in the case of time-dependent products, product destroying, bargaining stage of resource allocation is avoided.

### FIELD OF THE INVENTION

The present invention relates to a dynamic resource allocation platform and method for allocation of time related resources and more particularly but not exclusively to a platform for supporting dynamic allocation of data communication capacity.

### BACKGROUND OF THE INVENTION

Data networks supply enormous amounts of data capacity to large numbers of users. The usage patterns on the network tend to change very rapidly and dynamic allocation of the network capacity is a huge computational problem.

A commonly used method of managing such a network is to provide certain users with guaranteed bandwidth levels, at a certain cost, and to leave the remaining capacity to be shared between smaller users without any guarantee of availabilty. However, such a method avoids entering into the complexity of the problem. Individual users rarely use all of their capacity all of the time, but rather tend to fall into certain usage patterns having peak usage times and minimal usage times.

Furthermore if a new service is developed at a given location, the sudden appearance of the new service may upset existing network resource allocations, and one of the key issues associated with a managed data network is that the traffic distribution of a new service is initially an unknown variable which dynamically changes as a function of usage patterns and service growth. Therefore, commercial launches of new services require smart mechanisms that enable cost-efficient dynamic resource trade and allocation. Without such a mechanism, there is a risk of undermining the commercial viability of the service deployment.

Today, different technologies, such as traffic shapers, policy-based management and dynamic provisioning attempt to engineer and smooth the network traffic. These technologies however focus on network management and therefore obscure the underlying commercial aspect of the problem.

Reference is now made to FIG. 1, which illustrates the current situation. A provider 10 (i.e. carrier, service provider, etc.) is the entity that provides the network services to its customers. The provider may sell its own services, or other providers' services.

The customer is the entity that receives services from the provider. A customer may be a subscriber, business organization, SOHO, or another service provider that buys/leases communication services from the provider. Two customers, 12 and 14, are shown in FIG. 1.

As shown in FIG. 1, the provider 10 runs a provider network 16. The service networks 18 and 20 which represent service allocations over the provider network 16 to the individual users, for example as a WAN for a very large multi-location user or a VPN. The service networks 18 and 20 are set up as sub-domains within the provider's network 16 that may be allocated to the individual customer. Different ‘service networks’ can each be assigned to a different customer, although all are carried by the provider network.

Nowadays the business/commercial relationships are handled manually, which means that it can take days to weeks to set up an individual service network to the satisfaction of both parties. The current slow commercial process leads to static allocation and therefore to inefficiency and consequent loss of potential additional revenue. The system is unable to respond to situations such as the sudden popularity of a given server due to the presence of a new website.

Reference is made to the following documents, the contents of which are hereby incorporated within by reference:

J. Collins, C. Bilot, M. Gini, B. Mobasher “Mixed-Initiative Decision Support in Agent-Based Automated Contracting”; In Proc. Of the Fourth Int'l Conf. On Autonomous Agents, pages 247-254, June 2000,

J. Collins, R. Sundareswara, M. Tsvetovat, M. Gini, B. Mobasher “Search Strategies for Bid Selection in Multi-Agent Contracting”;

J. Collins, C. Bilot, M. Gini, B. Mobasher “Mixed-Initiative Decision Support in Agent-Based A utomated Contracting”, and

F. Stzidarovszky, M. E. Gershon, L. Duckstein “Techniques for Multi-Objective Decision Making in System Management”; Elsevier Science Publishers, B.V. 1998.

Nemo Semert, Raymond R.-F. Liao, Andrew T. Campbell, Aurel Alazar “Pricing, provisioning and peering: Dynamic Markets for differentiated internet Services and Implications for network Interconnections”, Colombia University and InvisibleHand Inc.

### SUMMARY OF THE INVENTION

According to a first aspect of the present invention there is thus provided a resource allocation platform for allocating resources between a provider and a plurality of users for a resource allocation price, the resources being duration dependent resources, the platform comprising:

an agent-based interaction mechanism for allowing the provider and the plurality of users to indicate required and surplus resources, and

a pricing engine, associated with the interaction mechanism, for ascertaining a resource allocation price.

Preferably, the pricing engine comprises a learning mechanism for learning demand behavior of individual users, therefrom to provide the price.

Preferably, the demand behavior is an observed demand price curve for a respective user.

Preferably, the pricing engine further comprises a differentiation mechanism for altering the price by applying a user based differentiation policy to the price.

Preferably, the learning mechanism is a per-user neural network.

Preferably, the learning mechanism is a neural network assigned per a cluster of users.

Preferably, the demand behavior is an observed demand price behavior for a respective user, the resources comprise a plurality of different products and wherein the observed demand price behavior comprises a curve per product, the learning mechanism being operable to prepare a separate price-demand curve for each product.

Preferably, the resources are data communication capacity resources.

Preferably, the resources are one of a group comprising bandwidth, duration, rate access, CPU access, trunk access, cache memory, quality of service, and combinations thereof.

Preferably, the resources comprise a plurality of different products, each one of the products being defined by a respective duration and at least one of bandwidth, rate access, CPU access, trunk access, cache memory, and quality of service.

The platform preferably comprises an allocation engine associated with the pricing engine, the allocation engine being operable to allocate available resources using rules, according to availability and according to respective resource cost outputs of the pricing engine.

Preferably, the allocation engine is further operable to allocate the available resources in such a way as to maximize a predetermined utility function.

Preferably, the allocation engine is operable to allocate capacity by maximizing an overall utility along a time continuum, wherein utility components for future points along the time continuum are calculated by including terms for probabilities of bids occurring at respective ones of the future points.

Preferably, the allocation engine is operable to carry out optimization of a mix within a group of products.

Preferably, the optimization comprises measuring changes in utility over changes in allocation between the products, and to allocate capacity from products showing lower changes in utility to products showing higher changes in utility.

Preferably, the agent-based interaction mechanism comprises a broker agent per user and a broker agent per provider.

Preferably, the agent based interaction mechanism further comprises an inter-provider broker agent.

Preferably, the agent-based interaction mechanism comprises broker agents for translating requests from respective users and providers into offers and bids, therewith to interact with other broker agents.

Preferably, the resources are apportionable into products being portions of a total amount of the resources and wherein the price engine is operable to build in a risk cost factor to respective products, such that the cost factor is inversely related to a size of a respective portion.

Preferably, the duration-based resources are apportionable into products having different time durations and wherein the price engine is operable to build in a risk cost factor to respective products such that the cost factor is inversely related to a size of a respective time duration.

Preferably, the duration-based resources are apportionable into products having different bandwidths and wherein the price engine is operable to build in a risk cost factor to respective products such that the cost factor is inversely related to a size of a respective bandwidth.

Preferably, the duration-based resources are apportionable into products having different bandwidths and wherein the price engine is operable to build in a risk cost factor to respective products such that the cost factor is inversely related to a size of a respective bandwidth.

According to a second aspect of the present invention there is provided a method of managing a time-dependent resource between at least one provider and a plurality of users, the method comprising:

assigning a broker agent to each provider and each user to translate requests concerning the resource into offers and bids,

using learned demand behavior of each user to assign a price to offers and bids concerning the user, and

allocating resources according to a predetermined utility function based at least partly on the assigned prices.

The method may further comprise using further differential information of each user together with a provider pricing policy to arrive at the price.

According to a third aspect of the present invention there is provided an interface, for interfacing between resource allocation platforms, the resource allocation platforms being for allocating resources between a provider and a plurality of users for a resource allocation price, the resources being duration dependent resources, at least one of the platforms comprising:

an agent-based interaction mechanism for allowing the provider and the plurality of users to indicate required and surplus resources, and

a pricing engine, associated with the interaction mechanism, for ascertaining a resource allocation price,

the platforms interfacing with each other over junctions,

the interface comprising:

an agent for each platform at each junction, the agent being a part of a respective agent-based interaction mechanism, and further comprising an inter-platform protocol for exchanging resource allocation data with a corresponding agent of a respective interfacing platform, thereby to support inter-platform resource allocation across the junction.

Preferably, the inter-platform protocol comprises a loop avoidance mechanism for preventing resource allocation data from looping between platforms.

Preferably, the loop avoidance mechanism comprises assigning identification data to an instance of resource allocation data and wherein the protocol comprises making passing on the resource allocation data dependent upon a test of the identification data. Preferably, the identification data is a randomly generated number.

Preferably, the randomly generated number is a relatively large number, thereby to reduce to negligible proportions the probability of two instances being assigned an identical number.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a simplified diagram showing the current situation vis a vis network resource allocation and commercial relationships,

FIG. 2A is a simplified schematic diagram showing how providers and customers are linked by brokers and a virtual trading floor according to a first embodiment of the present invention,

FIG. 2B is a simplified schematic diagram showing a resource negotiating platform according to a further preferred embodiment of the present invention,

FIG. 3 is a simplified diagram showing relationships between different providers superimposed on relationships between a provider and his customers, according to a further preferred embodiment of the present invention,

FIG. 4 is a circular flow chart showing interactions relating to the virtual trading floors of FIGS. 2 and 3,

FIGS. 5-7B are simplified sequence diagrams for different kinds of requests made over a virtual trading floor according to the present invention,

FIG. 8 is a simplified flow chart showing a pre-trading procedure for a request to buy from a customer over a trading floor according to a preferred embodiment of the present invention,

FIG. 9A is a simplified flow chart showing a pre-trading procedure for a request to sell from a customer over a trading floor according to a preferred embodiment of the present invention,

FIG. 9B is a graph showing points of operation for use by a price engine of the present invention,

FIG. 10 is a typical demand price curve for use by a price engine of the present invention,

FIG. 11 is a simplified schematic diagram showing an allocation engine according to a preferred embodiment of the present invention,

FIG. 12 is a simplified flow chart showing a procedure for allocating capacity over a virtual trading floor according to a preferred embodiment of the present invention,

FIG. 13 is a simplified schematic diagram showing interrelationships between users over a network, and

FIG. 14 is a simplified diagram showing a series of platforms interfacing via brokers over junctions, in accordance with a further preferred embodiment of the present invention.

### DESCRIPTION OF THE PREFERRED EMBODIMENTS

The present embodiments disclose a resource allocation platform for allocating resources between a provider and a plurality of users at a certain price differentiated for different users, the resources being time, that is to say duration, dependent resources such as communication data capacity. The platform comprises: an agent-based interaction mechanism for allowing the provider and the users to indicate their requirements and to translate the requirements into offers and bids, and a pricing engine for ascertaining a resource allocation price for the offers and bids. The pricing engine uses a learning mechanism for learning demand behavior of individual users so that it can translate their requirements into a price, which is fair to them and fair to the provider. Thus, the time-consuming, and in the case of duration-dependent products, product destroying, bargaining stage of resource allocation is avoided.

The platform preferably allows for parceling of the resources into products of given time duration and quality of service and a risk factor may be introduced into the price of the product according to the duration. Trading of resources may be on demand but future and option trading of the resources are also supported.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

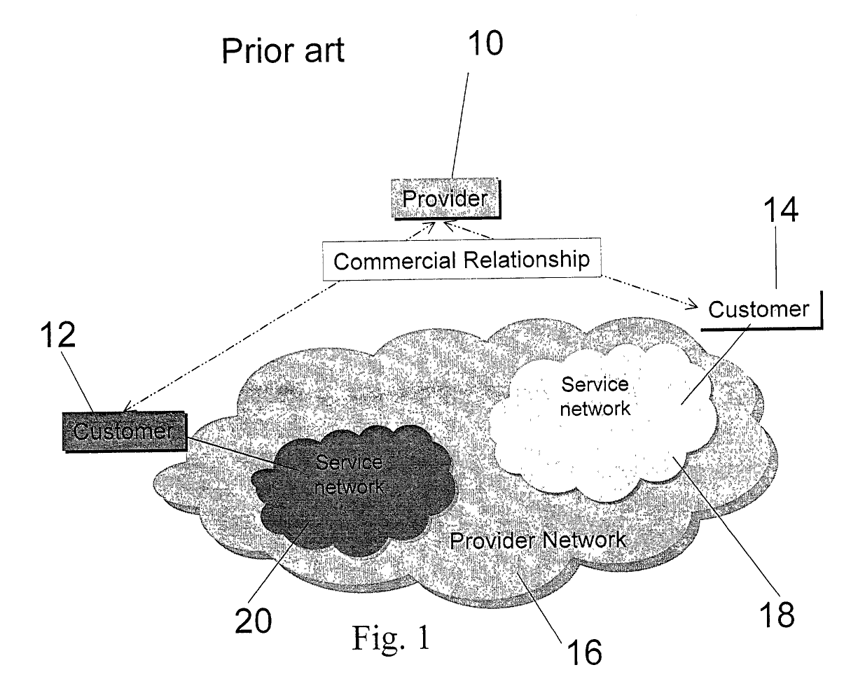

Reference is now made to FIG. 1, which is a simplified diagram showing the current situation vis a vis network resource allocation and indicating commercial relationships between parties concerned. As discussed in the background above, a resource provider 10 operates a network 16 which contains service networks per customer. The allocation may be rigid in that particular customers may be given a fixed guaranteed bandwidth, or the allocation may be dynamic in that bandwidth on demand is provided to the customer, the customer paying only for bandwidth used. In the latter case, bandwidth is generally provided on a first come first served basis, or on a normal distribution basis and there is very little attempt to apply underlying commercial concerns to the dynamic distribution of bandwidth.

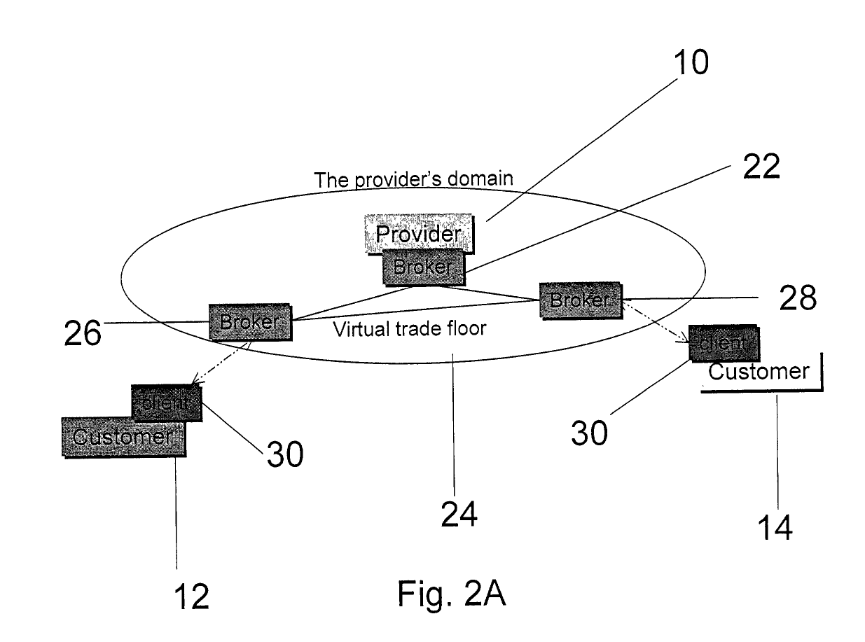

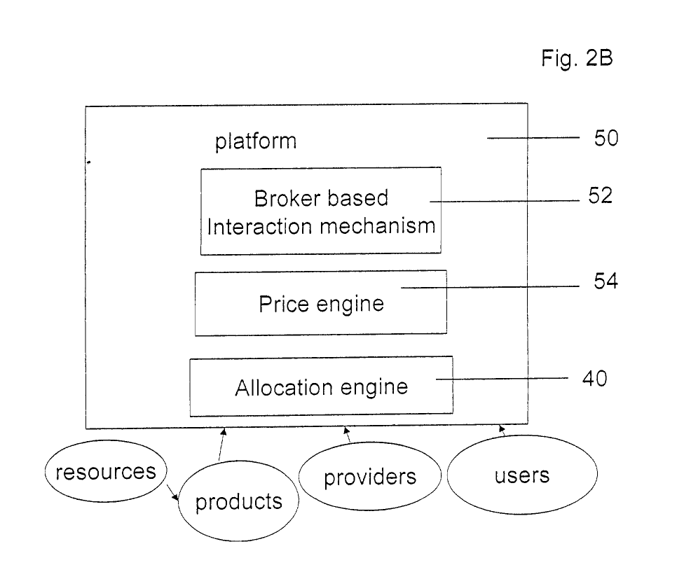

Reference is now made to FIG. 2A, which is a simplified schematic diagram showing how network resources are made available using a first embodiment of the present invention. In FIG. 2A, parts that are the same as those in previous figures are given the same reference numerals and are not referred to again except as necessary for an understanding of the present embodiment. A provider 10 offers and bids for products via a broker 22 over a virtual trading floor 24. The broker 22 is preferably a software module. Customers 12 and 14 also offer and bid for products over the virtual trading floor, each via his own respective broker 26 and 28. A product is typically the availability of a given amount of bandwidth with a given quality of service for a given amount of time. Preferably, a separate virtual trading floor is defined for each product, so that there is one trading floor for 10 Mb for 10 minutes and a separate virtual trading floor for 5 Mb for an hour.

As the trading floor and the broker agents are virtual, each customer is preferably connected thereto via a client program 30.

Preferably each broker agent is controlled by the provider 10. Each customer manages his trade activities via a single broker agent and the broker agents conduct auctioning amongst themselves over the trading floor 24. Customers can perform two actions, ask and bid, and both asking and bidding may relate to buying or selling of resources, as will be explained in greater detail below. The provider is preferably able to differentiate the auction, meaning differentiate between different participants.

Reference is now made to FIG. 2B which is a simplified diagram showing a platform 50 according to a preferred embodiment of the present invention. The platform comprises a broker based interaction mechanism, which comprises virtual agents called brokers who are assigned, as shown in the previous figure, to respective providers and users. The brokers manage the requests of the users and providers regarding the resources and translate them into bids and offers that can be exchanged with other brokers over the trading floor.

A price engine 54 attaches prices to the bids and offers based on learned information of the users. As will be explained below it preferably learns a demand price curve for each user for each product and uses that curve together with the quantity of the resource indicated in a respective request to arrive at a price. Other factors may be used such as provider trading policies and the like. An allocation engine then allocates the resource based on current availability and a predetermined utility function, which may take into account prices included, by the price engine, in the respective offers and bids.

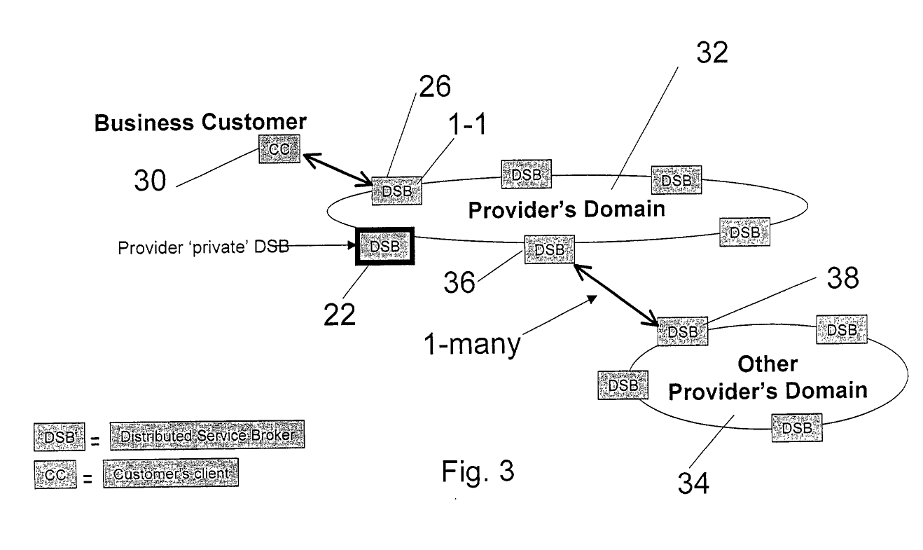

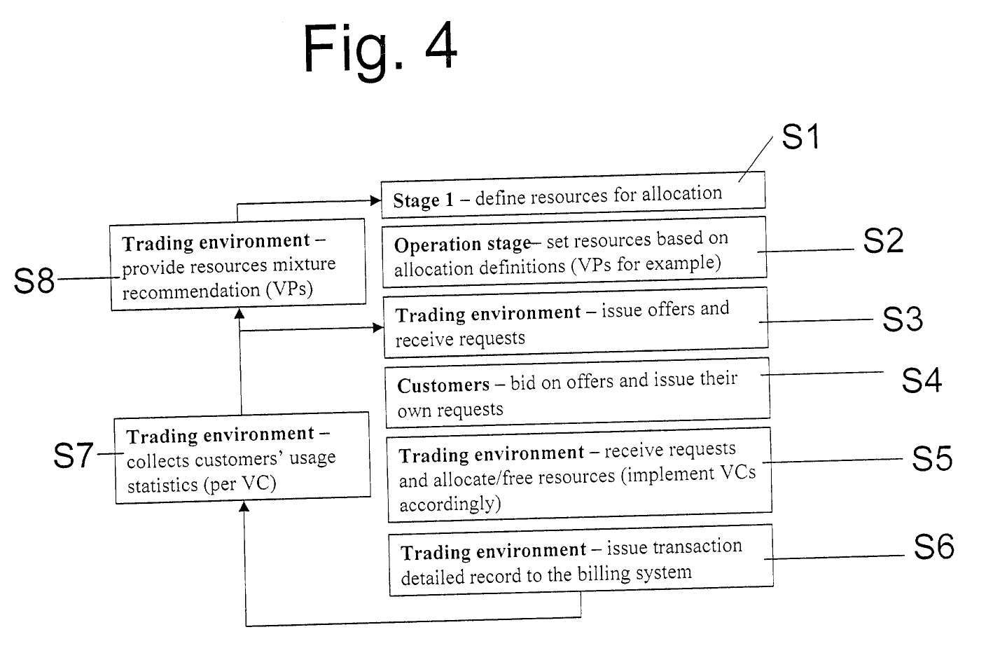

Reference is now made to FIG. 3, which is a simplified diagram showing how the platform of the preferred embodiments may be used when the principle provider 10 requires resources from another provider. Parts that are the same as those in previous figures are given the same reference numerals and are not referred to again except as necessary for an understanding of the present embodiment. In FIG. 3, DSB represents Distributed Service Broker, and CC represents Customer Client. In FIG. 3, client 30 of a customer is connected to the provider domain 32 via a broker agent as discussed above. However, due to lack of availability at the provider domain, capacity needs to be obtained from a different provider having his own provider domain 34. To this end there is provided an inter-domain broker agent 36, which communicates with broker agents of another domain, such as inter-domain broker agent 38 of provider domain 34. The two inter domain broker agents preferably negotiate for resources in the same way as intra-domain brokers. As will be discussed in greater detail below, there is preferably provided a protocol for communication between inter domain brokers. Preferably the protocol addresses security and privacy issues and additionally addresses the issue of loop avoidance. Loop avoidance is provided in order to overcome the problem of offers or bids reaching a given destination several times from different paths, and is explained in greater detail below. Preferably, each broker serves one customer. Each intra-domain broker operates one to many against other brokers and each inter-domain broker operates one-to-one against another inter-domain broker. Reference is now made to FIG. 4, which is a simplified circular flow diagram showing high-level aspects of operation of a platform according to a preferred embodiment of the present invention. In a first stage S1, resources available for allocation are defined—these are the products that are to be traded within the provider domain. The following stage, S2, allows the resources to be set up over the network infrastructure, which is to say time dependent bandwidth units for allocation. In a stage S3, the trading environment, which is to say the provider brokers, issue offers and receive requests for trading. In a stage S4, the customers bid on offers and issue their own requests.

In a stage S5, the trading environment receives requests and allocates and or frees resources, which is to say it implements allocation of the virtual products amongst the customers accordingly. It is noted that the flow of resources is not simply from provider to customer. The customer, who may have obtained resources on a long term basis, can allocate them back to the provider on a short term basis when the customer is not using the resources. In general, if the provider is short of resources, it is more efficient to buy back from customers unused resources than it is build more capacity or not to supply the demand, and thus the platform includes the possibility of allowing customers to sell back unused resources to the provider.

In a stage S6, the transactions are logged, typically for the purpose of billing. In a stage S7, the trading environment, which is to say the platform, collects customer usage statistics. Patterns obtained from the customer usage statistics may later be used to assist with smooth running of resource allocation. In a stage S8, the platform provides a recommendation as to improve the product mixture and have a better resources allocation that increases the provider pre-defined utility. That is to say it decides what kind of available bandwidth parcels to offer the customer. The procedure then continues with stage S1 or, if there are no changes, then with stage S3.

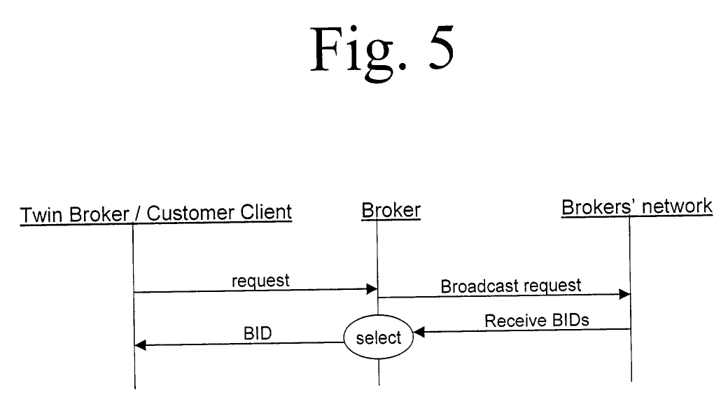

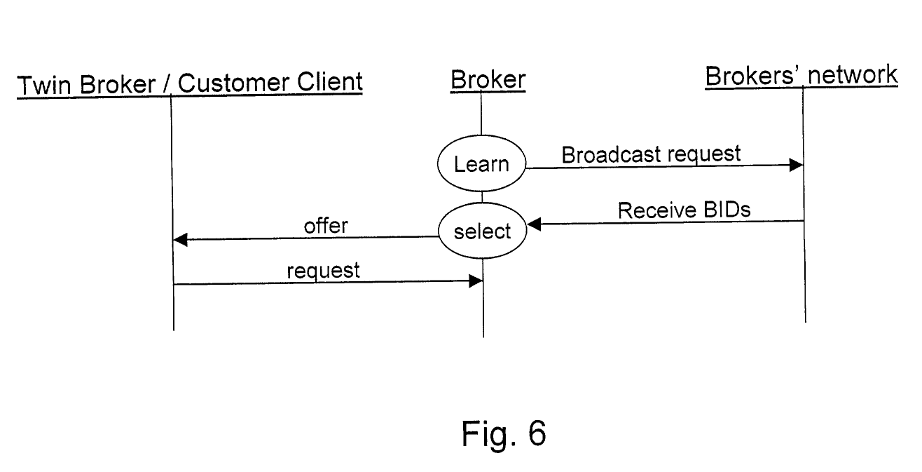

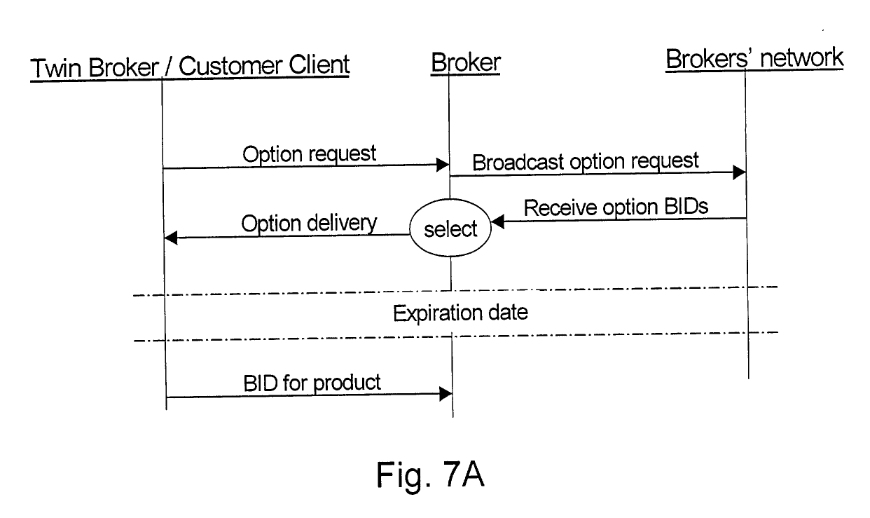

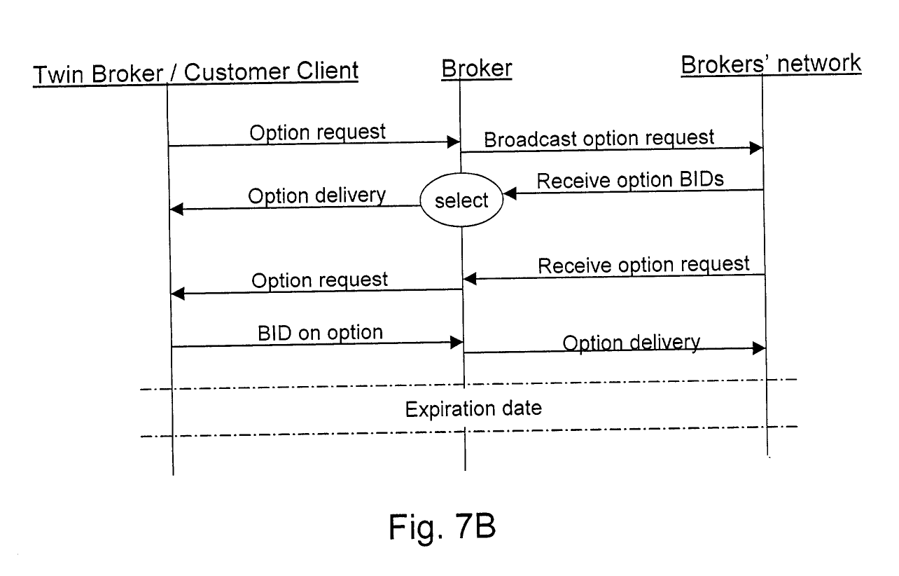

In the following four figures, FIGS. 5-7B, four different allocation cases are considered. FIG. 5 illustrates a product-requesting case in which customers wish to buy (or to sell) products, starting at the moment of making a request, or in a future specific moment. FIG. 6 illustrates a product-offering case in which the provider, who has learned and analyzed his customers' behavior, would like to offer them products to buy (or to sell). FIG. 7A illustrates a first level options trade, particularly useful for risk management, in which the provider and the customers buy or sell an option to buy/sell (e.g. put/call option) a product at a specific date for a specific price. Fourthly there is the second level options trade, which creates a derivatives market, in which the provider and the customers wish to continually trade (e.g. buy and sell) with options, for their values up to their expiration dates.

Reference is now made to FIG. 5, which is a simplified sequence diagram illustrating the product-requesting case. The sequence is initiated when the customer issues a request to to his local (provider supplied) broker. The request can be a buying or selling request as explained above. The provider's broker broadcasts the request to all other brokers in the network, which is to say the trade floor. The brokers reply with BID offers and the broker serving the initiating customer collects the BIDs, selects the best BID and uses that best BID as the basis for an offer to the customer. Provider trade rules may be used to modify the offer so that the offer does not exactly correspond to the BID.

The following examples are possible scenarios:

1. The provider issues sell-requests for selected products. The sell request defines the capacity involved and sets a minimum price. The sell requests are broadcast to all brokers and each customer may BID, with the quota and the price.

2. A customer issues a buy-request for products to a certain capacity level. The buy request preferably defines the maximum price or the required quota. The requests are broadcast to all brokers and each party (the provider and the customers) may BID, using the defined quota and the price.

Reference is now made to FIG. 6, which is a simplified sequence diagram illustrating the product-offering case. In the product offering case the provider's broker has learnt the typical usage patterns of his served customer. Based on the learned information the broker broadcast requests to buy or to sell to all other brokers. The brokers respond with bid offers from which the best is selected and an offer is made to the customer. The customer then answers with a yes or a no.

The following example is a possible scenario:

Suppose one customer generally requests certain products or product types each working day between 10:00 and 13:00. The broker learns this pattern and then broadcasts requests to set up an inventory for the customer. As he does so, the broker offers the products to the customer at an acceptable price, the acceptable price being determined from the demand curve. The result is that the provider can buy the products for the customer in advance and obtain a better deal than if it were done on-demand. Similarly the customer receives a quicker response.

Reference is now made to FIG. 7A, which is a simplified sequence diagram illustrating the first level option trading case. The sequence is initiated when the customer issues a request to buy or to sell an option (put or call) to the provider's broker operating with him. The broker broadcasts the request to all other brokers in the network and the brokers reply with BIDs offering to buy or sell options as appropriate. The broker that serves the customer collects the option BIDs and selects the best to be presented to the customer. At the expiration date, the twin-broker/customer client issues a BID (yes/no) to exercise the option and buy (sell) the product.

Reference is now made to FIG. 7B, which is a simplified sequence diagram illustrating the second level option trading case. The sequence is an extension of the previous sequence. However in this sequence the option owner can receive a request and sell his option, or provide an option request (to sell). This may be carried out at any time up to the expiration date, while the last option holder, at the expiration date, issues a BID—yes or no for exercise of the option and allocation of the product according to the terms of the option.

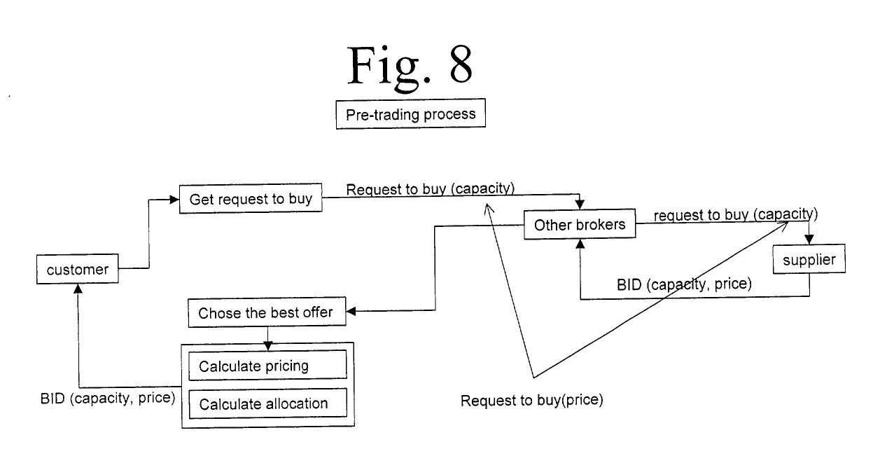

Reference is now made to FIG. 8, which is a simplified flow diagram illustrating the sequence of activities when a customer issues a request to obtain data carrying capacity, referred to herein as the pre-trade process. The customer firstly issues a request, generally via the broker who serves him. The request is passed on to other brokers who supply bids for providing capacity currently available from suppliers. The best bid is selected. The best bid is a bid that maximizes a pre-determined utility function, that can be developed from a combination of parameters such as—the customer ID, the profit, the supplier ID and so fourth, together with respective importance weightings. Thus:

U=U(w₁customerID,w₂Profit,w₃supplierID, . . . )

wherein U is the utility score, and the w's represent weighting coefficients allocated to the respective suppliers, providers and customers.

Pricing is then calculated using a pricing engine, which will be discussed in greater detail below, and finally the capacity is allocated. It is noted that when the market is long, that is to say supply exceeds demand, prices are set in such a way as to maximize revenue. Furthermore, the full request of the customer is fulfilled and then the customer may be presented with additional offers of spare capacity based on his usage patterns. On the other hand, when the market is short, then prices tend to rise anyway. In both cases allocation is preferably made to maximize utility.

In the case of short supply there is no possibility of offering spare capacity. The customer places an ask request to buy needed capacity. His request is broadcast to all relevant brokers in the usual way. At this point the brokers bid using their own pricing mechanisms. Now it is likely that some of the brokers place bids that accord with the customers' pricing. The engine decides which bidder has won and rewards him with his bidding price. In addition the customer that placed the initial request preferably gets the product subject of the offer, but with a price that differs from that of the seller's offer. If the seller is the provider then the price paid by the customer may be that set by the provider however.

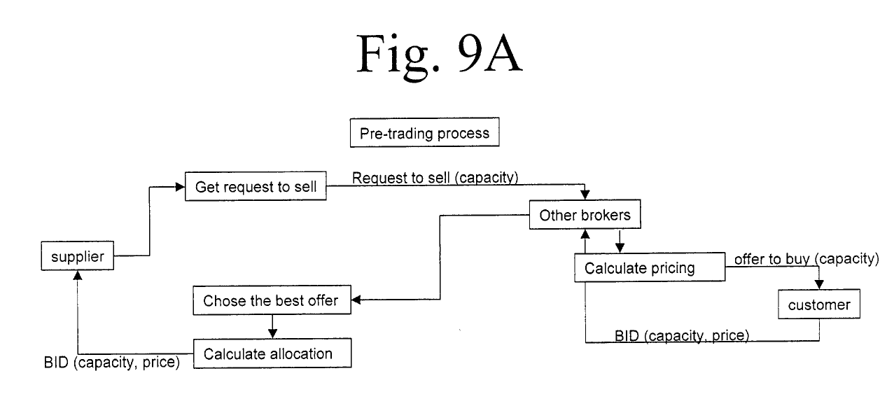

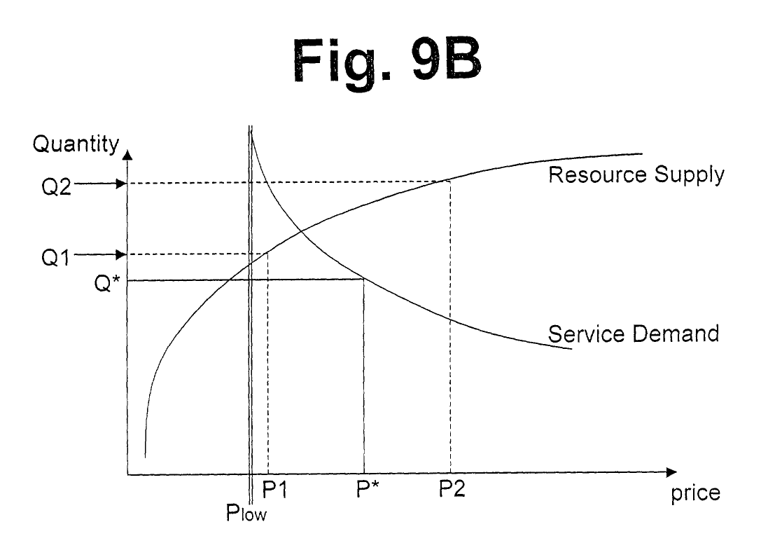

Reference is now made to FIG. 9A, which is an equivalent flow chart to that of FIG. 8, except that it applies to the case in which the customer wishes to sell unused capacity back to the supplier. The basic procedure is the same but in certain respects is the mirror image of the previous case. In the following only the differences are highlighted. In FIG. 9A, once again the best offer is defined as the offer that maximizes a predetermined utility function. Likewise, pricing is carried out using the price engine, but is made at the side of the party offering to take the resource. Allocation is once more made to maximize utility.

In general, the same product can be offered for different time durations. If the price is directly proportional to the time then it is in any user's interest to buy only the current demand for the minimum duration possible. It is therefore advisable to provide a mechanism that introduces a factor into the pricing mechanism to encourage purchase of longer time units.

In the following, a product is defined as a bandwidth quota for a specific duration D=(ts−te); (Where ts—is start time and te—is end time). The duration D may be defined by the provider or by the customer, as one of the product's attributes. The duration parameter is the major difference between trade with bandwidth and trade with products.

Each product has different supply & demand behavior, thus for Np products we define Np trade floors. For example there may be trade floors to trade quotas for durations of a day, a month, a week, an hour, 20 min, 1 min etc.

Let [D] be a group of predefined durations D=(d1, d2, . . . ); for example d1=1 min, d2=20 min, d3=1 hour, . . .

Then, to avoid revenue cannibalization, products with the same capacities, for the same starting point but with different durations are preferably

$${P}_{i - 1} = {P}_{i} \cdot \frac{{d}_{i - 1}}{{d}_{i}} \cdot risk\_cost ; \qquad {d}_{i} > {d}_{i - 1} , risk\_cost > 1$$

Risk_cost symbolizes the additional amount that the market agrees to pay for buying capacity of shorter duration. If, for example, it is possible to buy capacity for one day and for one hour, then the ‘one hour’ product price is preferably set at 24 times less then the ‘one day’ price, multiplied by the risk_cost factor. Thus, factoring in for risk of non-utilization inherent in buying over the longer term, the longer term products are cheaper.

It is possible to expand the use of such a mechanism, referred to herein as an anti price cannibalization mechanism, by specifying similar risk cost factors for different types of fragmentation, for example bandwidth fragmentation. Thus a risk cost factor may be defined to reward those who buy larger bandwidth products.

Having considered how the underlying price is altered to reflect different products, a pricing engine is now discussed to explain how an asking price is obtained in individual cases.

The pricing engine preferably provides a mechanism that enables the provider to ask using the right offering price, meaning an offering price that is likely to be accepted.

A first issue is that of differentiation. In a pure auction, prices are fully defined by the market, in that all participants are invited to bid. Then, based on the bid prices received a spot price is calculated. Various mechanisms may be used to arrive at the spot price from the bids, for example a first price mechanism, a second price mechanism etc. The end result is a fully transparent liquid market which is often not favored by carriers.

The preferred embodiments use what is known as a differentiated trading floor, in which the mechanism in use looks at a level definition assigned to individual participants. The mechanism may be transparent but is not necessarily so.

An additional issue is duration dependence. Unlike discrete products, such as gold and oil, telecom resources are duration-dependent products. Duration-dependent means that one of the product's attributes is its supplying time. In other words, it means that every passing moment is a potential product that can be sold. Duration dependence is to be contrasted with time dependence, a term which means that the value of the product changes with time. The latter applies to most products. With communication connected products, time dependence of the product includes cyclical time dependence, in that bandwidth may be more expensive at certain times of the day and on certain days of the week.

In conventional dynamic auctions players can place bids continuously, until the auction is closed; however the product has a solid definition and the seller loses nothing as a result of the duration of the auction.

By contrast, in auctioning of time-dependent products, during the auction period the seller has a dilemma between on the one hand closing the deal and rewarding the winner with the current last offer which may be particularly to the winner's advantage, and on the other hand continuing to look for a better offer and losing the revenue that could be generated had the product been sold now.

In time-dependant product auctions there is thus a need for a prediction mechanism that knows right at the start what to offer, when to offer it and at what price, and in the present embodiments this may be achieved by learning each and every customer's behavior individually.

Such learning may be achieved as follows:

For every customer:

For every product (capacity, duration, ts, te):

Learn the demand curve, that is demand as a function of price D(P).

Using the demand curve find the best price to deliver the maximum revenue, while the prices themselves are limited within the boundaries defined to avoid cannibalization.

$${{D}^{l}}_{i}^{j} ( P ) + P \cdot \frac{\partial {{D}^{l}}_{i}^{j} ( P )}{\partial P} = 0$$

Since demand is an individual function, it can be differentiated; which means that the provider can set different risk_cost factors (for different fragmentations—duration, bandwidth etc. as explained above) and different minimum wholesale prices (for buying for the maximum duration, a year for example, or the maximum bandwidth).

Trade policies may be set as follows:

define a minimum price, being the price for buying the longest duration product, and

define risk cost factors to apply to different durations of product. Note that the minimum price and the risk_cost may provide differentiation factors. That is to say they may be defined for each customer individually, thereby providing the platform with the ability to differentiate between customers.

Reference is now made to FIG. 9B which is a graph providing a summary of the function of the Pricing Engine. As explained, the pricing engine's task is to provide any issued ASKs with a best suitable price. When providing an offer to buyers, its goal is to maximize income, and therefore the best price will be P*. However, if the total balance of capacity, of all BIDs and ASKs at a specific calculated moment is Q2, which means that the minimum price should be P2 according to the availability of the resource, then P2 may be set as the ASK price. If, on the other hand, the balance is Q1, indicating P1, then the ASK price may be P*. In any case, to avoid price cannibalization as discussed above, the offered price must not be lower then P_{low}, which is the lower boundary.

Since there are many demand curves, one per customer per product and per time of allocation, it is almost impossible to handle a multi-product-multi-customer trade floor using conventional means. However it is possible to set up a neural network for each customer or for each identifiable cluster of customers, since customer behavior in a communication network often easily clusters, and the neural network can then be trained to provide the best price for the specific product being requested. That is to say, preferably, the neural network learns the right price per product having a defined capacity, duration, and ts.

Using the neural network as described above is sufficient for normal, that is steady state or nearly steady state situations. However, in reality there is burst behavior as well. Burst behavior can be due to an event. Events may be internal, for example a network problem. Alternatively the events may be external, for example the launch at a particular location of an attractive new web site. In order to deal with such burst behavior it is possible to define a class of customers that has a similar response to an event occurrence. If all customers behave normally, that is according to their demand curves and then suddenly a few responses are received with aggressive bids, meaning they are willing to pay more then usual, that means that capacity is short and greater supply is needed. Being able to recognize such events makes the system smarter, and each individual customer's behavior at a given event is preferably stored so that at the next event the platform is able to make a better guess as to the customer's likely behavior.

To find the right opportunity (to sell or to buy) the broker uses the following procedure:

The broker learns the player's usage behavior. As he does so, the broker builds up a usage profile, which preferably means it finds a set of fuzzy groups that describe the behavior of chosen measured parameter distributions as a function of time-of-day, day-on-week and specific dates.

Then the broker classifies its specific player's profile into one or more profile classes. A profile class is a fuzzy group that defines a usage behavior pattern. In the profile class, each member (a player's usage profile) is assigned its own level of membership, preferably according to fuzzy logic rules.

As explained above the broker recognizes exceptions to normal behavior, and preferably treats such exceptions as new opportunities that need to be examined. The current behavior is compared to both the usage profile and the profile class. If an exception is found to the behavior so defined it implies an opportunity related to the specific customer, as well as to other customers having a membership in the profile class group that the specific customer belong too (up to the membership function). To explain the identification and subsequent exploitation of such an opportunity we consider three examples of exceptions that may signal such an opportunity:

a. Suppose that one customer's service network is generally 35% utilized at 10 AM on a workday morning, and then one day he requires 75% of the resource.

b. Suppose that one customer's usage profile belongs to a given profile class A that specifies Internet surfing from 10 PM for two hours, however, one day the player surfs at 11 AM.

c. Suppose that one customer usage profile strongly belongs (say more then 0.95) to a profile class A. One day an outside event (unknown to the system) occurs, causing 30-40% of the members in the group to change their usage behavior. This means that our specific customer stands a high chance of changing his behavior as well.

Finally the broker prioritizes the new opportunities, that is to say it prices these opportunities, and may select an opportunity for direct use in interesting, or making some kind of offer to the players. The prioritizing mechanism is based on expected utility theory, wherein the provider predefines weighting rules and the system then ranks the opportunities based on their outcome utilities.

It is noted that fuzzy logic may create situations of recognizing more then one opportunity, and sometimes the different opportunities recognized can be in conflict. For example, one exception may be translated into a sell opportunity, for players belonging to group A, but the same event is interpreted as a buy opportunity for all members of group B. As group A and group B are not necessarily orthogonal there is a finite probability that a certain player may belong to both groups and is thus simultaneously subject to the mutually contradictory offers. In such a case the platform preferably distinguishes between the two opportunities, prices them and then decides which opportunity suits the given player better.

If, at any given time, the provider has spare capacity, that means that he is able to provide all the capacity he anticipates that the customers wish to purchase. In such a case, the price may be evaluated as above and the quota that is estimated is taken straight from the individual customers' demand curves D(P). The provider can thereby estimate how much capacity is going to be sold and how much will be left as spare at every moment.

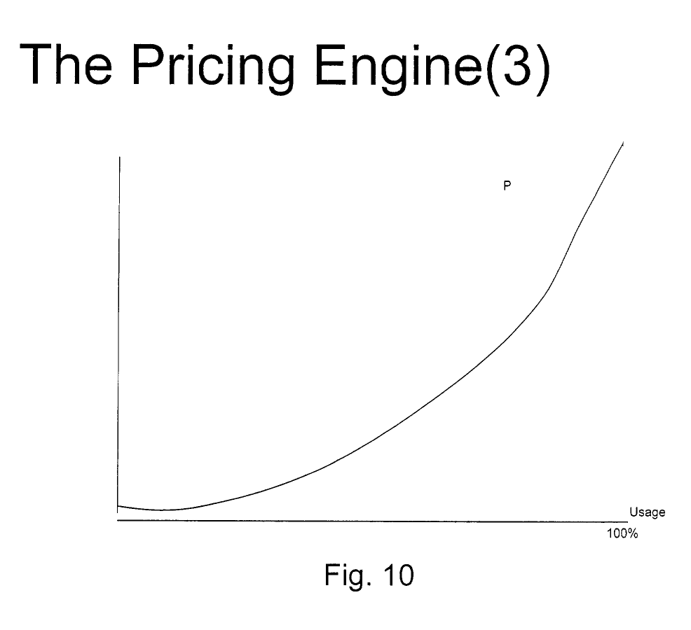

However, if capacity is short, or if the provider does not place enough capacity for sale, that is to say the product on offer from the provider is small compared with the product demanded by customers, then there is preferably provided a mechanism that adjusts the prices accordingly. In this context, reference is made to FIG. 10 which shows an example of a function that takes the current usage and provides an adjusted price level.

The provider preferably controls the prices of its resources through his broker. The provider broker preferably controls the products and knows their utilization patterns. When a new request for a product is received, the broker preferably looks at his inventory to determine the availability of the product i.e. how many items are available at the requested starting time for the requested duration based product.

The provider defines the pricing curve as a function of usage—P(usage) as shown in FIG. 10. The curve of FIG. 10 applies to a market in short supply, however, if the market is long then it is up to the provider to offer for sale fewer products and thereby bring about a price rise. Now, if the provider is a monopoly that the above described activity can be a way to increase the prices. However, if the provider is subject to competition, then it may need to find a new product mix. The new product mix may result in a pseudo-monopoly giving a certain amount of price control, or the prices may have to be adjusted based on supply and demand of the market as a whole.

For every traded product the broker manages accounts that summarize usage at specific moments.

The broker then calculates the price to be offered.

The provider's broker defines the provider's product prices as they are sold from the inventory. The defined price becomes the base product price. Then every broker that asks for the product subsequently updates the product price and all the prices of products having shorter duration.

If the provider wishes to reduce or increase the price, all he needs to do is to redefine the available capacity for trading, and the usage percentages may be automatically changed and thus the prices.

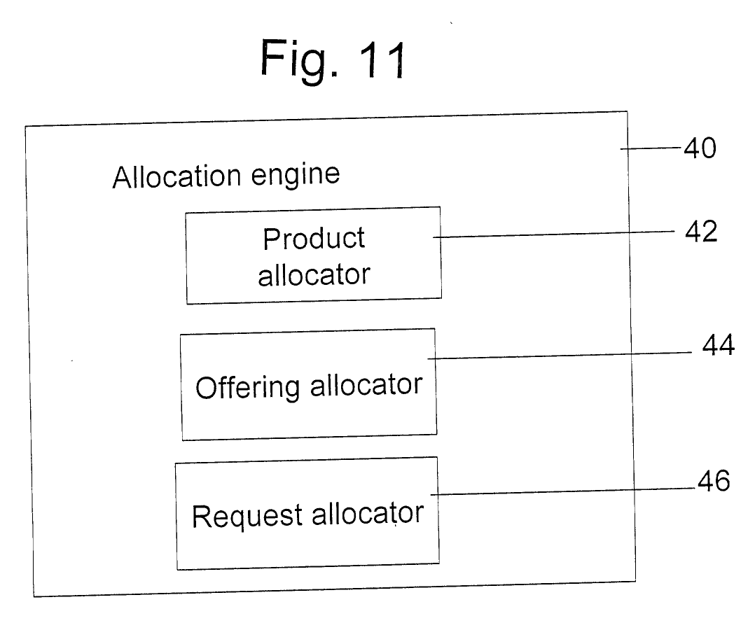

Reference is now made to FIG. 11, which is a simplified diagram of an allocation engine for use with the present embodiments. Allocation engine 40 allocates the available capacity firstly into different product types and then as offers and then to the individual customers.

The allocation engine has three main parts as follows:

1. a product allocator 42 which finds the optimal product mixture,

2. an offering allocator 44, which allocates capacity for offering, as part of the ASK procedure,

3. a request allocator 46, which allocates capacity to requests, as part of the BID procedure.

### Optimal Products' Mixture

Firstly, the operation of the product allocator 42 is considered. It is noted that a product is defined by:

1. media—bandwidth (ATM-VP, or MPLS LSP), CPU resource usage, cache memory, . . .

2. capacity—bandwidth: Source, destination and Bit rate, CPU: Hz, cache memory: place, memory

3. QoS—

4. Duration

5. Start time

6. Repetition rate—every day, every week, . . .

7. others—any other attributes the provider wishes to add to differentiate its products.

The mission of the allocation engine is to define the best product mixture in terms of how much capacity to allocate to each product. For example, given 10 Mb free link and two services that are provided, one 500K and one 250K, the question is how much of the link to make available as units of the 500K product and how much of the 250K product? Another allocation example may be product bundling for different destinations. Given a 600M pipe and ten different destinations, how much of the pipe should be allocated to each destination? Is there a destination that needs more then any of the others?

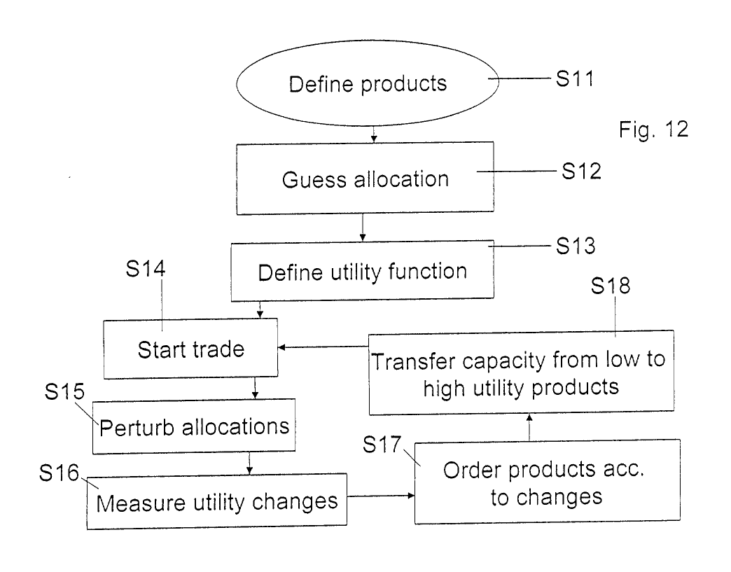

Reference is now made to FIG. 12, which is a simplified flow chart showing a procedure for dynamically determining an optimal product mix, which procedure is suitable for use by the product allocator 42. To find the best product mix according to the present embodiments, the procedure:

S11. defines the products,

S12. allocates capacity (# of units) using an initial guess,

S13. defines a utility function in terms of:

revenue,

traffic,

other measured parameter or combination of parameters regarding specific customer(s) and/or route(s)

the utility function preferably supports

meaning that utility is increasing with capacity but the rate of increase is falling.

Following steps s11-s13, a loop is now entered comprising steps s14-s17 below:

S14. Let the trade start and measure the utility generated from each product,

S15. Increase the capacity assigned to certain products and measure the change in their contribution to the utility,

S16. place the products in order according to levels of utility change, and

S17. free capacity allocated to products that have the smallest utility change and give it to products that have the greatest changes in their utility.

Allocate Capacity for Offering (ASK Procedure)

Returning now to FIG. 11, and the offering allocator 44 is now considered in greater detail. In making offering allocations there are two possibilities for the ask mode—ASK the customer to buy capacity and ASK the customer to sell capacity.

The price to buy is calculated as explained above in respect of the pricing engine. For such a price the platform may anticipate the customer bidding for capacity equal to D(P). In offering to buy, there is thus no specific role for an allocator.

However, in the case of making an offering for sale to the provider, the trade floor preferably operates a reverse auction—that is to say the trade floor finds the best available offer, meaning who is offering the highest quota at the lowest price. Such a sell-back-to-the-provider mechanism is attractive and can be an advantage in competitive markets, since if customers know that there is a potential of being paid back for capacity they don't need, they are encouraged to buy the capacity from the provider who gives them such an opportunity. Furthermore they are encouraged to buy larger capacity quotas over longer periods, knowing that there is a reduced risk of losing out over short term periods of lower utilization.

Use of the offering allocator to buy back capacity from customers is useful when the provider is short of capacity. The provider may also wish to create a virtual short supply to create a price increase, and the allocation engine is able to facilitate such a wish by not allocating available capacity.

In the case of the customer buying the provider offers a price and asks the customer how much he wants, whilst having made an a priori allocation based on the customer's demand curve. In the case of the customer selling, the provider indicates the capacity he needs and asks the customer to set a price, the provider then taking up the capacity according to the price offered. The provider thereby becomes the customer of his customer.

An alternative case of a customer selling is as follows: A broker agent may determine that it needs to buy capacity, and, as discussed above, this may be due to its customer issuing purchase commands, or it may be based on learned behavior of the customer. The customer's broker therefore issues a corresponding request for capacity. All the other brokers on the trading floor receive the requests and, subject to any given provider policy, they may issue requests to their own customers to sell the required capacity.

Allocation of Capacity to Request (BIDs Procedure)

The function of the request allocator 46 is now considered. There are two types of request that the provider is asked to provide BIDs for, these being a request to buy and a request to sell.

If a customer issues a request to sell, then the request is broadcast to all brokers. Some of the brokers determine that the offer may interest their customer. In such a case the offer is preferably approached as follows:

Firstly they check the product price for the customer,

Secondly they investigate relevant paramters such as any currently applicable selling policy, the current logic condition of the price-cost margin, the customer ID, the seller ID, available capacity in the provider inventory, and other parameters.

If the above investigations prove satisfactory, then the brokers allocate the offer to any customer having an identical quota to that being offered.

If the customer issues a request to buy and if there is no resource limitation on the trading floor, then the price is preferably evaluated using the pricing engine. As mentioned above, the pricing engine operates, using the respective customer-product demand-price curve, to offer the price that attains maximum revenue.

If the customer issues a request to buy and if the market is in short (or virtual short) supply of capacity then the BID price will rise, again according to the dictates of the pricing engine and the respective customer-product demand-price curve, and the allocation may be smaller then requested. The allocation will be according to policy, which may typically be as follows:

The maximum price gets a full allocation, then the second highest, and so forth, or in proportional to a price/revenue balance, thereby to maximize the utility. Utility is typically a function of different parameters with their wight of importance, which its first derivative is positive and second derivative is negative.

In the following five parts, the dynamic differentiated auction is considered from a more mathematical perspective.

### Part 1: Terminology

Part 1 defines basic terminology that is relevant for use in the following chapters. This part provides conceptual descriptions followed by mathematical notations, while the following issues are covered:

The resources and the services markets.

BIDs, and ASKs.

The Future markets.

The Outcry Auctioneer's game.

The Virtual Trade Floor game.

In the telecommunication industry it has became common to talk about two complementary markets—resources and services. Bandwidth (as well as frequencies, cache memory and CPU time) are items that may be traded in the resources market. Voice minutes, SMS messages, video streaming and so fourth are type of services that may be traded in a services market.

Let us define the set of all participants, hereinafter players, including buyers and sellers, by I={1, . . . , I}. A player's identity iεI as subscript indicates that the player is a buyer, and as a superscript indicates that the player is a seller.

In the resources market, a network owner sells bandwidth, meaning he sells links between his POPs (points of presence, i.e. his network's edges). When a buyer purchases a specific link, the seller is supposed to allocate him the relevant capacity and the buyer is supposed to pay for the link.

In the services market, a service operator sells to the network owner the rights to deliver his service traffic. Although the service operator may pay the network owner, the service operator is considered a seller because in such a market the network operators are competing to get the services' traffic.

Such markets are considered as complementary markets with respect to one another since a bottleneck in one market may lead to overload in the other and v.v. Furthermore, too much bandwidth over a specific route means there is a lack of traffic, and too much traffic implies a lack of resources.

Nowadays the bandwidth resources market is measured in bandwidth units (i.e. bit-rate) and the services market is measured in minute units (mainly phone calls minutes). The mapping function between these markets is dependent on services definitions and mixtures of different services, as shown in the following example:

Taking for example an E1 (2 Mb/sec) link that can handle 30 uncompressed calls, each call requires 64 Kb/sec. Thus 6 Mb/sec (i.e. three E1s) sold for one hour are theoretically equivalent to 5400 call minutes. We say theoretically because it is possible that the buyer will not have enough traffic to fill the whole resource, and in addition, technically he has to leave a certain number of slots free as a buffer, to take new calls. Generally the size of the buffer is calculated based on an average call duration, the ratio between answered and seizure calls-ASR, and the post dial delay-PDD.

Now, let us furthermore assume we have video service, defined with a bit rate of 500 Kb/sec, so that those 6 Mb/sec could deliver 12 video channels simultaneously. Beside the technical limitations of buffer requirements, the services mixture is an important parameter that defines the equivalent function between the two markets products.

Let CoS={CoS₁ . . . CoS_{Ncs}} be a set of N_{cs} classes of potential services that a service operator can chose to deliver, while SM′={(CoS₁, aₛₑᵣ₁), . . . , (CoSₛ, aₛ)} is a subset of CoS that defines the services' mixture chosen by service operator i to be sold in the services market. The services' mixture is a set of pairs, each defining the class of service and the service amount allocated by the service operator—aₛₑᵣ (for example number of call minutes, or number of video channels).

A CoS defines attributes that are relevant to specific services. In the following we relate to two parameters: QoS (delay, packet loss, jitter, etc′) and BR (bit-rate). Other attributes may be handled in a similar way to that in which the QoS is handled herein.

We may define traded product capacity (bought by player i from player j) cᵢ^{j}=cᵢ^{j} (in,e,BR,QoS), which in the resources market defines a link between the ingress (in) and egress (e) points and in the services market defines the amount of service traffic between source and destination (ingress and egress points). The two products are equivalent up to the point of technical tolerance (α(α≦1)) to compensate buffering requirements:

cᵢ^{j}|_{service}=α·cⱼⁱ|_{resource} (1)

For example, if the service operator tolerance is 70% utilization, then 2 Mb/sec voice quality link sold by player i to player j for 3 hours in the resources market is equivalent to 0.7*2M=1.4M (which are 3780 call minutes) sold by player j to player i in the services market.

However, while dealing with services it is also common to buy minutes' capacity to be deployed over the long term (say a week or a month). For example, a carrier may buy/sell 3000 calls' minutes per month; meaning that on average he receives or sends 100 minutes every day, distributed over the day. In such a case we need to expand the above relation (1) to deal with a more comprehensive function such as cᵢ^{j}|_{service}=cⱼⁱ|_{resource} (α, t, i, j, service), which means that it is time, buyer, seller, service and tolerance dependent. We further assume we can define such a function and adjust its parameters, based on historical traffic monitoring. Thus, from that point of view we further use the term capacity cᵢ^{j} for both markets, since they are complementary.

Now, in the real world, both players look for trades that may contain more than one resource or service. Therefore, we may expand our capacity definition as follows:

We assume a seller j trades with resources/services capacity components defined in the vector

$${\underline{C}}^{j} = ( {{c}^{j}}^{1} , … {{c}^{j}}^{L} )$$

with L capacity components, each identified by its attributes

$${{c}^{j}}^{l} = {{c}^{j}}^{l} ( in , e , BR , QoS ) ,$$

We may define that the capacity component

$${{c}^{j}}^{l}$$

defines the entire pipe or total communication capacity between the ingress and the egress points. We also assume that there is no overlapping, which means that for every l and k there is no

$${{c}^{j}}^{l} ∈ {{c}^{j}}^{k} .$$

In a case of resource capacity it is the seller's responsibility to define the trade granularity between every two routers or between two edges of its cloud. The same applies in the case of service capacity, in which case it is the seller's responsibility to define the service granularity—that is the number of minutes taken as the underlying unit on the basis of which are defined the specific services or packages of services. It is noted that no overlapping means that if the capacity traded is packages then trade with specific services is not allowed.

In both markets, products change hands after setting a mutual agreement between the buyer and the seller. These agreements define the payments one party has to give the other. The Dynamic Differentiated auction supports three types of compensation, which may be pre-defined between the parties as a general trade agreement. We may assume player i buys from player j and they issue a payment agreement between them pᵢ^{j}=pᵢ^{j} (cost, risk, fee), while:

cost—is a currency based payment the buyer requires to pay the seller for the goods,

risk—is agreed compensation one party pays to the other, in case the agreement is not fulfilled. The risk value is assumed to cover the other party's loss from being unable to complete the trade,

fee—is an additional cost being paid to the contract issuer. Usually it is the maximum between a minimal payment and some percentage of the cost.

The DD auction algorithm provides two mechanisms that enable handling of the trade. If the buyer initiates the trade then he places a bid, and if the seller initiates the trade then he places an ask.

Suppose player i is buying from player j. Then he places a bid bᵢ^{j}=(qᵢ^{j}, pᵢ^{j}), meaning he would like to buy from j a quantity qᵢ^{j} (of capacity cᵢ^{j}) and is willing to pay (or being paid) a unit price pᵢ^{j}.

Since carriers build their selling strategy by differentiating among their buyers, the inter-carrier market is found not to be pure liquid. On this point the reader is referred to R. Jacob “Does communication become commodity? ” QSDG magazine; September 2001, the contents of which are herein incorporated by reference. Therefore, unlike the classic auction, we define that a seller j places an ask sᵢ^{j}=(qᵢ^{j},pᵢ^{j}), meaning he is offering a player i a quantity qᵢ^{j} (of capacity cᵢ^{j}) with a ‘floor’ differentiated price of pᵢ^{j} per unit.

The future market is a well-known financial tool that is used to manage investment risk since in some respects it enables reliable forecasting and allows investigation of future trends. The DD auction supports two types of contracts—the futures contract and options. There is also the possibility of developing a secondary market, where these contracts may be traded. The implications of such a development may have direct influence on the first markets (the services and the resources), and therefore we discuss these possible influences in the Pricing Engine chapter.

The Future Contract

Suppose player i wishes to buy a future contract starting at tₛ>0 and finishing at t_{E} from player j of a resource or a service l, then he places a bid

$${{b}_{i}^{j}}^{l} = ( {{q}_{i}^{j}}^{l} , {{p}_{i}^{j}}^{l} ) ,$$

where

$${{q}_{i}^{j}}^{l} = ( {{c}_{i}^{j}}^{l} , {t}_{s} , {t}_{E} ) .$$

Note that if tₛ=0 this is a SPOT market while tₛ>0 defines a future market.

At tₛ we have three situations: 1) the buyer takes all his requested capacity and the seller allocates him all the requested capacity, 2) the buyer takes part of his requested capacity (or even nothing) and the seller allocates him all that he takes—i.e. the buyer breaks the contract, and 3) the buyer takes all his requested capacity and the seller allocates him part (or nothing)—i.e. the seller breaks the contract. The second and the third cases may be agreed between the parties to involve a certain amount of penalty payment, referred to herein as risk. It is also possible to consider behavior of ATM networks, where the players may trade with UBR or VBR (unsigned bit rate or variable bit rate) capacity. In such a case it may typically be agreed by the players that the capacity is flexible and no party is committed—thus the risk is zero.

There is a certain probability of occurrence for each case and, based on a bid's history and the usage profile, the DD algorithm considers these probabilities.

We use the same terminology to define the ask procedure for a future contract,

$${{s}_{i}^{j}}^{l} = ( {{q}_{i}^{j}}^{l} , {{p}_{i}^{j}}^{l} ) ,$$

however the ask procedure for a future contract is in practice a tool for the seller to offer different packages to his customers. If no buyer signals with a bid, then there is no contract and there is no obligation from the seller side to supply the capacity.

The Option

An option to buy—referred to as a call

$$( {{q}_{i}^{j}}^{l} , {{p}_{i}^{j}}^{l} , {ExD}^{l} )$$

—means that a seller j issues a buyer i an option to buy capacity

$${{q}_{i}^{j}}^{l}$$

of resource or service l at a specific price

$${{p}_{i}^{j}}^{l}$$

at a specific date

$${Exd}^{l} ,$$

which is the expiration date, and the seller of the option is obligated to this contract. It being an option the buyer however is under no obligation to use the option. If the expiration date is past and the buyer has not realized his option, then the opportunity is lost, and the option has no value.

An option to sell—put

$$( {{q}_{i}^{j}}^{l} , {{p}_{i}^{j}}^{l} , {ExD}^{l} )$$

—means that the buyer issues the seller an obligation to buy capacity

$${{q}_{i}^{j}}^{l}$$

of resource or service l at a specific price

$${{p}_{i}^{j}}^{l}$$

at a specific date, and the seller has the option to realize the contract, until the expiration date

$${Exd}^{l} .$$

Once again, if the seller does not take up his option by the expiry date then the option expires without value.

In the same way as with the differentiated ask definition, we may define the option value as a differentiated value. The option issuer may write a different option of the same resource/service quantity to different customers, and so the option takes a different value.

We use a Black and Scholes model to evaluate the current option value. It is noted that this model is just an example and there are many other models that can be used to value options.

$$\begin{matrix}{C}_{0} = {S}_{0} N ( \frac{ln ( {S}_{0} / X + {r}_{f} T )}{σ ( \sqrt{T} )} + \frac{σ ( \sqrt{T} )}{2} ) - \\ X {ⅇ}^{- {r}_{f} T} N ( \frac{ln ( {S}_{0} / X + {r}_{f} T )}{σ ( \sqrt{T} )} - \frac{σ ( \sqrt{T} )}{2} )\end{matrix} \qquad ( 2 )$$

Where:

C₀—is the current option value.

S₀—is the current differentiated SPOT price of the capacity, which is the

$${{p}^{l}}_{i}^{j}$$

of the current ask.

X—is the option realization price, which is the

$${{p}^{l}}_{i}^{j}$$

defined in the option.

r_{f}—is the current labor debit value.

T—is the expiration date,

$${Exd}^{l}$$

N—is the normal distribution function

σ—is the normal deviation of the current differentiated SPOT price S₀.

Thus, the seller may use his history information to evaluate the future price of the product, and then to place a call option. Since all prices are differentiated, the option value likewise has a differentiated value. The decision regarding the quota is discussed hereinbelow in the part Allocation Engine.

In a general auction the outcry auctioneer presents the seller objectives and he has two roles: 1) to place asks and, 2) after the bidding to allocate the capacity. In other words we can say that in the allocation process the auctioneer is required to allocate service or resources capacity to current bidding buyers and to future bidding buyers (i.e. to place asks).

We may assume that at any specific moment the auctioneer deals with N_{B} bids, with requests for capacity quantity defined by a matrix Q^{j} having N_{B} columns and L rows, wherein each component

$${{q}_{i}^{j}}^{l} ( n ) = ( {{c}_{i}^{j}}^{l} , {t}_{s} , {t}_{L} ) {\vert}_{n ∈ {N}_{B}}$$

defines a capacity quantity

$${{c}_{i}^{j}}^{l}$$

requested by i from j in the n-th bid (i.e. how much capacity

$${{c}^{j}}^{l}$$

to buy) which is required at tₛ until t_{E}. Please note that N_{B} is instantaneous, since every moment the seller and the buyers can places different number of asks and bids respectively.

For a component l, the relationship between

$${{c}^{j}}^{l}$$

and the sum of Q^{j} row

$${{Q}^{j}}^{l} = {\sum }_{n = 1}^{{N}_{B}} {{q}_{i}^{j} ( n )}^{l}$$

defines its economy of sale; if we take out the asks placed by the seller then if

$${{c}^{j}}^{l} < {{Q}^{j}}^{l} {\vert}_{{N}_{B} ∈ Buyers}$$

the product is traded short; if

$${{c}^{j}}^{l} > {{Q}^{j}}^{l} {\vert}_{{N}_{B} ∈ Buyers}$$

the product is traded long, and if they are equal then we have equilibrium between supply and demand.

We may define that when buyer i places a bid n with tₛ=0, it means he would like to buy the whole capacity

$${{q}_{i}^{j}}^{l} ( n )$$

of resource or service l, which he is bidding for. Thus, seller j may allocate him

$${{a}_{i}^{j}}^{l} \cdot {{c}^{j}}^{l}$$

such that

$${{a}_{i}^{j}}^{l} \cdot {{c}^{j}}^{l} \leq {{q}_{i}^{j} ( n )}^{l}$$

and the buyer will not be disappointed (i.e. the buyer takes all the capacity allocated for him).

However, in future market trading, it is possible that some asks will not be achieved, as well as some future contracts and options. There are different penalties (risk) for these non-achievements, of which some will be paid to the seller and some will be paid by the seller.

Option expiration dates and forward contracts' realization dates are the link between present and future market trading. Thus, the seller process should consider both markets, while placing asks and allocating capacity.

Thus, the auctioneer game consists of three questions: 1) how much capacity to allocate for new asks, 2) what should be the new asks' prices and 3) how to allocate service or resource capacity among the current bids. This is a classic multi-objective decision making (MODM) game, which is discussed in the multi-objective decision part below and is used to formulate the auctioneer's game:

Let

$${C}^{j} = ( {{c}^{j}}^{1} , … {{c}^{j}}^{L} )$$

be the resource/service capacity vector of seller j and let Q^{j} be the resource/service capacity requests matrix, where each component

$${{q}_{i}^{j}}^{l} ( n )$$

defines a specific n-th bid (or ask) allocation request of resource l to buyer i. Then for every l the auctioneer needs to:

Maximize:

$$E ( U ) = {\sum }_{k = 1}^{K} U ( {W}_{k} ) {p}_{k} \qquad ( 3 )$$

Subject to

$${{\underline{a}}^{j}}^{l} ∈ {A}^{l} {I}^{j}$$

wherein E(U) is the expected utility,

pₖ is the probability of outcome k, and

Wₖ is the resulting wealth of the decision-maker, if outcome k is realized.

$${{AI}^{j}}^{l}$$

are seller j's alternative allocations for resource/service l and

$${{\underline{a}}^{j}}^{l}$$

is the allocation vector of the resource/service, which support ∀i, j:

$${\sum }_{n = 1}^{{N}_{B}} {{a}^{j}}^{l} ( n ) \leq \frac{{\sum }_{n = 1}^{{N}_{B}} {{q}_{i}^{j}}^{l} ( n )}{{{c}^{j}}^{l}} \qquad ( 4 )$$

In simple words, the seller needs to decide what percentage ratio of capacity component to allocate a specific bid (or ask) to a buyer, that maximizes his expected utility, while some of the asks can be placed by over-booking.

We define the ‘extra’ ratio for capacity component:

$${{Ext}^{j}}^{l} = \frac{{\sum }_{n = 1}^{{N}_{B}} {{q}_{i}^{j}}^{l} ( n )}{{{c}^{j}}^{l}} \qquad ( 5 )$$

As described above this ratio presents the economy of the trade. If

$${{Ext}^{j}}^{l} > 1$$

than we have a short, or artificial short situation, where the bids and asks quotes more capacity than available. If

$${{Ext}^{j}}^{l} < 1$$

than the market has extra capacity, which means that the seller has to place asks in order to sell these extras. Accordingly, it is possible to rewrite (3) as follows:

$${\sum }_{n = 1}^{{N}_{B}} {{a}^{j}}^{l} ( n ) \leq {{Ext}^{j}}^{l} \qquad ( 6 )$$

which means that the total sum of the allocation percentages should at least equal the extra ratio. If all bids receive their complete quota, than the sum is equal to the extra ratio, however since it is possible that some buyers will be allocated less quota then they bid for, it is then that the extra ratio may be bigger than the total sum.

A special case applies when

$${\sum }_{n = 1}^{{N}_{B}} {{a}^{j}}^{l} ( n ) = {{Ext}^{j}}^{l} = 1 , \qquad ( 7 )$$

in which the market is in balance and there is equilibrium between supply and demand. We call this point an equilibrium point and the pricing strategy is developed hereinbelow around this point.

Theorem 1: In present market trading, if all bids are placed with tₛ=0, if the extra ratio is

$${{Ext}^{j}}^{l} < 1 ,$$

then pₖ=1.

Proof: If all bids are placed with tₛ=0, it means that there is no traded option and as defined above the buyer takes all resources allocated to him. If the extra ratio is less than one, then it means that there is enough capacity for all bidders, thus the probability for all bids to be realized is one.

Remark: In future market trading, even if

$${{Ext}^{j}}^{l} < 1 ,$$

we have pₖ≦1, since it is possible that some future bids, for example of the options type, may chose not to buy the entire requested capacity.

In a further example the seller takes into account not just the currently available bids but also likely bidding behavior over a relevant future timescale. Thus if at a current time a provider has bids to fulfill at a low price but he knows that within a number of minutes or hours the price is likely to rise then he may choose not to fulfill current bids but rather retain the capacity for greater overall profit in the near future. A future likelihood of a sale may be considered in terms of overall utility containing a term for the probability of the bid occurring.

The auction procedure

We define the auction as an on-going procedure that repeats every ΔT_{cycle}. In every cycle (say at time t_{cycle}) the ‘outcry’ needs to deal with different type of bids and asks:

1. Existing and running bids—all bids that the Auctioneer had allocated capacity to at t<t_{cycle}.

2. New received bids for current allocation—all bids that have been received as a response to asks placed in the previous cycle (i.e. at t=t_{cycle}−ΔT_{cycle}) their starting time being within the cycle time (i.e. t_{cycle}≦tₛ<t_{cycle}+ΔT_{cycle})

3. New received bids for future allocation—all bids that have been received during the current cycle as a response to asks for future contracts or options, whose starting time is after the cycle time (i.e. tₛ>t_{cycle}+ΔT_{cycle}).

4. Existing bids for future allocation—all bids that have been received before the current cycle (i.e. at t<t_{cycle}) as a response to asks for future contracts or options, whose starting time is after the cycle time (i.e. tₛ>t_{cycle}+ΔT_{cycle}).

5. Future bids that reach their expiration date or starting time during the current cycle (i.e. t_{cycle}≦tₛ,ExD<t_{cycle}+ΔT_{cycle}).

6. New asks for current market—new asks that the buyer can bid for in the next cycle.

7. Old asks for the current market—those asks that were placed prior to the current cycle. These asks may be replaced by new ones, with a new price and new capacity.

8. New asks for future products—new asks for future contracts of options.

9. Old asks for future products—old asks for future contracts of options.

In short the auctioneer procedure is as follows: the auctioneer may summarize all current required capacity and offer capacity. Based on the Extra value the auctioneer should determine the total capacity for new asks, and using the pricing engine should determine a price for every new ask.

It is assumed that the probabilities required to determine pricing and allocation can be evaluated from the bid history and the customer database. We also assume we can construct a utility function U(W), which maps the players' objectives from a measured wealth W to a level of utility. Such wealth parameters could be: bid pricing, bid quota, the difference between the bid pricing and the SPOT, the importance of the customer, or any other measured interest or logical rule. Based on the expected utility theory we may construct the decision-maker's utility curve U(W) to support two axioms:

1) the first derivative of U with respect to W is positive, i.e. the decision-maker always prefers more wealth to less wealth, and

2) the second derivative of U with respect to W is negative, i.e. each successive increment in wealth yields less additional (but still positive) utility.

The Auctioneer game presented above is a decision maker problem—the decision maker in question typically being the seller. In the telecommunication market all players act as sellers and buyers and if we expand the game presented above to deal with multi-players (i.e. multi-decision makers) then it is a virtual trade floor game.

Let assume there are I non-cooperative players, and the decision variable controlled by the i-th player is denoted by xᵢ. Then xᵢ is called the strategy of the player i. Let the objective function of player i be denoted by fᵢ, then fᵢ is called the pay-off function of player i. The set X of all possible decision vectors, x=(x₁ . . . x_{I}), is now called the set of simultaneous strategy. (In a particular case, when for all xεX, f₁+ . . . f₁=0 the game is called zero sum).

The solution of such multi-players game is a vector (x₁*, . . . xₗ*)εX called the equilibrium point of the game, if for all i and x,

fᵢ(x₁*, . . . x_{I}*)≧fᵢ(x₁*, . . . xᵢ₋₁*,xᵢ₊₁*, . . . x_{I}*) (i=1, . . . I)

The vector x*=(x₁*, . . . x_{I}*)εX is an equilibrium point of the game if and only if it is a fixed point of the mapping M, that is x*εM(x*), while

$$M ( \underline{x} ) = \{ \underline{y} \vert \underline{y} ∈ X , {max}_{y ∈ X} {\sum }_{i = 1}^{l} {f}_{i} ( {x}_{1} … {x}_{i - 1} , {y}_{i} , {x}_{i + 1} , … {x}_{l} ) \} . \qquad ( 8 )$$

In other words, the equilibrium point is a point at which no players change their strategy, because if they do so, their objectives will be less well fulfilled.

A simple way to look at the problem is to allow the players to play, each using his own decision making process to achieve the best choice (i.e. x*εX) for himself, given his objectives. The players' objectives (i.e. fᵢ(x)) may be measurable parameters such as profit and loss, or subjective parameters, such as risks and preferences.

However, in multi-players game every player has a large number of alternative routes, with different combinations of bidding/asking timing, directions, quality of service etc'. Here a preferred embodiment of the differential auction algorithm serves to determine the best player's strategy, considering cooperative and competitive relationships/strategies.

### Part 2: The Economy of Sell's Strategies

The core idea of implementing the differential auction in telecommunication network is to increase the trade dynamic. By doing so the auction increases the response flexibility and as a result the network efficiency increases. The outcome is that buyers enjoy new opportunities without the need to buy resources for the long term. In other words the unit price may be reduced in time, however the total income for the seller increases since resources are more effectively utilized. In order to ensure an overall revenue increase we need to set the price based on a sound economic calculation.

In general we see two market situations:

1) where resources are traded short and

2) where resources are traded long.

First we look at a scenario of the short situation separating present and future trading. Then we look at the long situation for present and future trading. This part provides qualitative analysis of the sell strategies; and provides the basics for the next two parts that define the pricing and allocation mechanisms.

Deficiency and Present Trading

When capacity is short it means there are bottlenecks in resources that require business-oriented management. This case is relevant for tier three service providers that lease limited capacity network resources, through which to run their service traffic.

In present-only trading, all allocated resources may be bought by the buyers, and it is very possible that some or all of the buyers will not get what they are asking for, due to the deficiency. Therefore, since the seller does not provide all the buyers' requests it is possible that the buyer will have to consider the risks involved in trading with such a provider. We discuss this issue in the buyers' game part herein. However, we refer here to two different situations:

1. The monopolistic seller: who can increase his prices until he reaches equilibrium, as in eq.7:

$${\sum }_{n = 1}^{{N}_{B}} {{q}^{l}}_{j}^{i} ( n ) = {{c}^{l}}_{j} \qquad ( 9 )$$

However, we should remember that we are dealing with differentiated SPOT prices, which means that the price may be evaluated according to the seller's trade roles and policies. Thus, although the pricing is an important parameter in the trade, other objectives should be considered to reflect the sellers' policy. For example: a seller might be interesting in a good relationship with a specific buyer, so he will wish to supply him with all his requests even in a shortage and even if he is not making the best offers.

2. A competitive market: meaning that the seller needs to adjust his pricing according to the market pricing level. If the market is efficient (i.e. prices are transparent) then eq.9 above is the result, since prices are evaluated by market forces. Therefore, the seller dilemma is to define the best mixture of services. A good mix will differentiate him from other sellers and as a result will bring him more revenue. The service mix will be dealt in the Allocation Engine part below.

Deficiency and Future Trading

The case of deficiency and future trading is interesting, mainly in the competitive environment. If the seller monopolizes the market, then he can raise prices to the equilibrium point (eq.9). In addition a monopolistic seller will have no motivation to sell options, because if he does so he gives his customers a better opportunity to manage their investments and therefore to compete with the seller in his own territory (if the buyer is a service provider as well). However, in a competitive market, sellers are always motivated to sell futures, to avoid situations of underutilized resources

If the sale is in a competitive environment, which probably is the more common situation, then although the seller has limited resources (i.e. less then the demand), it is possible that in the market there are enough resources and maybe even more then needed. Consequently the deficiency is only from the sellers perspective, and not from the buyers' perspective. If we have a non-cooperative game, between the sellers i.e. they are not organized as a cartel to keep their prices high, then the seller has to play a very sensitive game. On the one hand, he would like to sell all his capacity, but on the other hand, he wishes to protect his reputation. That is to say if he promises to allocate a certain amount of capacity, he should avoid being short and thus unable to fulfil his promises.

Unlike a monopolistic situation, where increasing prices can create a balance between supply and demand, here a simple auction may cause prices to reach the market pricing level. One of the most popular tools sellers use today, is to sell long term contracts. With this tool the seller guarantees his customer loyalty (at least for the contract's period), which means a guaranteed revenue stream. The future trade floor therefore adds additional dimensions to these long-term contracts—to create flexible trading and to expand sales opportunities. Thus the main issue is to determine the right offer mix to attract the buyers. With the right mix the seller can guarantee his revenues, up to the point that the buyer prefers to break the deals that is at the point where the penalty cost is less then the difference between the buyer's price and the market price.

Extra and Future & Present Trading

Technology developments have brought about the situation that most of the US and European markets have huge unutilized bandwidth resources. The resource market is generally long and in most cases it is a competitive market as well.

In a monopoly market, the seller controls the market price (up to the regulator limits). Therefore he can increase the prices up along the demand curve, to maximize the total revenues. The DD auction is unique as it sees every buyer as individual; and the algorithms disclosed herein learn the individual demand curves.

In such cases every allocation can be realized. Therefore, the seller game becomes less an issue of competing applications (over limited resources), but more an issue of pricing being offered in the ask stage in order to maximize the seller's expected utility.

Such a situation is similar to the classic auction in that the seller places ask requests and the buyer signals the amount he would like to buy. However, the long or short states of the market may merely be instantaneous situations. Thus if the buyer does not have a smart broker to act for him, he may not discover the seller's trading status. Therefore, he is likely to place bids with higher costs then the minimum that was presented in the ask request, to guarantee his desired allocation.

### Part 3: The SPOT & Future Pricing Engine

The role of the pricing engine is to provide the right prices to be placed within an ask request, thus sᵢ^{J}=(qᵢ^{j},pᵢ^{j}), where pᵢ^{j}=pᵢ^{j}(cost, risk, fee) for a specific service or a resource capacity which a seller i may offer to a potential buyer j The pricing engine consists of two steps:

1. Determine a common cost value for the offered capacity, and

2. Determine an adjust to provide a differentiated price (i.e. cost, risk and fee) for each and every customer, based on his SLA.

The pricing engine is as described above.

### Part 4: The Allocation Engine

The allocation engine is preferably designed to receive bids that include required quota and price from buyers. However, the platform also uses ask requests, which means the buyers may receive offers to buy specific quota for a specific price. In this case the seller may define the price and therefore the preferred embodiment may provide an algorithm to suit the pricing methodology.

Traditionally there are several allocation concepts, for example:

1. First come first served—which means that allocation priority is decided according to the bid time. In such a case the seller might lose potential income he may get from other bidders by not allocating the resource. However, with this role there is always a guarantee of maximum utilization. In short trading, maximizing utilization is not the main target, since the demand is greater than the supply. Therefore, such an allocation strategy is less attractive when the market trades in short.

2. Revenue proportional allocation—which means that the allocation is proportional to the bidders prices:

Revenue proportional allocation is preferably achieved by ordering bidders based on their bid prices and allocating resources accordingly. Bids at the same price split their quota proportionally according to the respective quantities requested. For example, assume three buyers who have placed the following bids respectively:

(55%, 1$), (25%, 0.7$), (50%, 0.7$), then the first player will get 55% of the resource, and players two and three will split the remain 45% between them—15% and 30% respectively. (Prices are per unit).

3. The PSP as defined in N. Semert, Raymond R, F. Liao, A. Campbell and A. Lazar, “Pricing, Provisioning and Peering: Dynamic Markets for Differentiated Internet Services and Implications for Network Interconnections”; Columbia University 2000, the contents of which are hereby incorporated by reference.

Using PSP, a player i gets the minimum of 1) his request, 2) the remaining bandwidth after making allocations to all others players that placed bids at a higher price. A player i is charged for the bandwidth allocated to him by the amount of money the seller could get from all other (that is remaining) players if he would not have allocated the bandwidth to the present player.

There are two major problems with each of these traditional allocation rules, firstly they assume a liquid market and secondly they do not consider the products as duration dependent. Since the telecom market is not in fact liquid and since it prefers to remain as such, in order to apply a system to the telecom market it is preferable to embrace a differentiated SPOT pricing method. Differentiated spot pricing means that allocation and pricing are set according to the seller's trade policies, that is differentially for different customers or different types of customers. In addition, duration dependent products require a mechanism that continuously examines current resources states and current BID and ASK requests to evaluate implications of current product allocation to the provider utility.

In the following we discuss the concept and the operation of such an allocation engine.

Firstly it is noted that old ask requests, that is ask requests that have been on the system for some time, are replaced by a new one if the utility of the new one is better, and this may be achieved by allocating zero capacity to the old ask.

Considering problem (3) as defined above, assume we have a group of objectives. Every allocation combination may receive a grade according to its fulfillment level and then it becomes possible to chose the combination that provides the highest rank in the light of the group of objectives.

It is preferable to create a group of measures, such as: quota, price, difference between differentiated SPOT and the bid's price, bid history (for example how much quota the buyer usually buys on average over a month, over days, or over specific hours), importance of the buyer, which may be defined in levels by the seller (e.g. gold, silver . . . ), and the application rank (as defined by the seller and the buyer before the trade). We preferably evaluate these measures for each bid. Each measure has its weighting function, as defined by the seller. The weighting function can be a weighting number or a conditional function. Then the expected utility may be evaluated for every bid. An implementation for solving the allocation problem can use the technique that was proposed by Gini—in practice trial and error. The technique guesses a solution, then checks the expected utility, and then attempts to improve it by changing the allocation and rechecking the utility. A preferred implementation extends the technique by adding a guessing mechanism, and also an additional allocation-adjustment mechanism, the latter being to handle not only present allocations, as received up to the point in time at which the calculation is made, but also duration-based allocations to adjust continuously at future moments.

The guessing mechanism may rely for example on dynamic learning of the players' bids, traffic behavior and service growth. It is also possible to use information from long-term market operation as a reasonable starting point for guessing for current market prices. Such a guessing mechanism provides a vector of probabilities regarding allocations at the calculated moment as well as corresponding expected revenues. In other words the new guessing mechanism provides an evaluation of the expected utility giving the possible allocation vector.

The allocation made, which provides a solution for problem (3) discussed above, is preferably proportional to the guessed expected utility, considering not just the current received BIDs but the entire body of received BIDs and ASKs and associated history, as follows:

We define a set of allocation rules to answer the question ‘how much does a specific player belong to a specific resource’ and the allocation is then carried out according to the answer to that question.

For example a rule may be set as follows, ‘if the bid has high expected utility then the bidder is associated with the resource’. In this case a membership function is accorded to the expected utility, so where it is higher it implies greater belonging and then the corresponding bidder receives more quota for that resource.

As another example, let us assume the following set of rules:

If the bid has high expected-utility then the bidder is associated strongly with the resource.

If the bidder is a strategic customer then he is associated with the resource.

If it is busy hour and the bidder is not a preferred customer then the bidder is not associated with the resource.

Each rule defines a different type of association or membership and one may use fuzzy AND and fuzzy OR functions to aggregate all these roles.

We may also use the fuzzy rules to define un-measured parameters, while measured parameters may be used for evaluating the expected utility function.

Since this technique considers current and future BIDs and ASKs it can handle duration dependent products allocation, while enabling market forces to direct allocation to an optimal solution.

Solution in the Allocation Space

One way to look at the problem that the allocation engine tries to solve, is how the provider should allocate its network resources to different services networks, whilst dealing with dynamic services. The solution is preferably an efficient algorithm that obtains different customers Asks for different products and different allocating times and produces as a result an allocation vector coupled with a vector of relevant pricing.

Dealing with dynamic services means that Asks may be for any different times in the future and for different durations. Therefore, to find a solution it is preferable to examine the impact of the players and their activities at each calculation point and for every balance point while predicting possible future activities. An iterative algorithm is required, whose efficiency and optimality depends on its predicting ability. Such a type of solution has been discussed hereinabove.

Another way to look at the above problem is to transform it into allocation space, where time becomes a parameter rather then a variable. By doing so one in effect freezes the time and the dynamics and deals with a static or semi-static problem. The idea is to take the multi trade floors model as discussed above and to set each trade floor to deal with trade of a specific duration product that may be allocated at a specific allocation time. It becomes apparent that the problem to be solved is how much resource to allocate to each and every trade floor and what should be the allocation and pricing mechanism within these trade floors.

To explain the solution concept we focus on a scenario in which a customer would like to buy products from the provider. A series of messages pass between the customer's client and the broker and between the broker and the trade floor, according to the protocols discussed above.

We assume that the provider defines the available products and the broker presents these products to his served customer. Each product presented includes the ingress and egress points, the capacity (e.g. required BW and QoS) and the duration.

As the customer issues a request for information regarding a selected product, the broker forwards the question to the trade floor that deals with the relevant allocation time and duration. Subsequent processing is detailed below. We assume that the trade floor provides a minimum expected utility that can be valid up to a pre-defined time. The broker then calculates the required price that benefits the provider and presents it as an offering to his customer, using a function such as:

Pᵣ=f(EXP(U(w)))

Finally, the customer can issue an Ask. The trade floor receives the Ask and allocates the product to the customer.

We now detail the trade floor algorithm.

As the broker receives a request for an offer, he transfers the request to a sub-module which maps the request from the customer's service network topology into the provider network topology. Such a map-new-service module preferably uses a searching algorithm on a price graph.

Let R=(L_{1,} L₂, . . . Lᵣ) be the provider network resources. Then the function map-new-service carried out by the module provides a subset of R^{s}=(L_{1,} L₂, . . . Lᵣ_{ₛ})εR which is the set of r^{s} links that support the new service s.

Each resource link Lj is marked or colored a with utility-cost tag. Initially the utility-cost tag will have been set by the provider as the minimum expected utility the provider wishes to obtain from any customer use. However, when a customer issues a request to buy, the utility cost of those resources that support the service are updated, which means that if the resource utility is higher, the customer is required to pay more for using these resources.

Then, for every resource that is part of the service there are three calculations to be made:

1. Find the total resource capacity for trade.

2. Find the total ordered resource.

3. Calculate the required resource expected utility.

The required expected utility to be offered to the broker is the sum of all expected utilities of resources being used.

The uniqueness of the proposed algorithm is that the required expected utility is calculated based on the availability and usage of the resource. If the resource is free at a specific moment, then its required utility is the minimum utility. However, if the resource was ordered by some services (i.e. by some customers), then its required utility increases.

Let u be the total ordered resource Lj for a specific moment; and a—be the total resource Lj that was allocated for trading for the same specific moment. Then, u can be considered as the total ordered resource, before the current request, or after the current request (e.g. u=u⁻¹+q) or any number between them (e.g. u=u⁻¹+q/β; while for β=2 it is the average between the ‘previous’ and the ‘after’. The parameter u can be set based on learned information regarding the buying probability of each ASK.

Let us define a trade floor for each resource Lj that deals with allocation of capacity for duration D at time Ta (which we call the balance point). The amount of resource available in each of these trade floors may be calculated every time there is a request for a price.

Let D=(d₁,d₂, . . . d_{N}_{_{D}}) be the vector of N_{D} different durations that the provider define to be sold as different products. Lets

$$A ( D , {T}_{a} ) = ( {{a}^{1}}_{{T}_{a}} , {{a}^{2}}_{{T}_{a}} , … {{a}^{{N}_{D}}}_{{T}_{D}} )$$

be the vector of possible allocations of resources to be available for trade in those trade floors that deal with N_{D} products that should be allocated at Ta for different possible durations D.

We may define two types of products—‘fixed allocation time’ and ‘flexible allocation time’. Products with a fixed allocation time can be scheduled for predefined times, for example a 24 hour product can be allocated from 0:00 to 24:00, or an 8 hour product can be scheduled to 8:00, 16:00 or 24:00. Products with flexible allocation times can be scheduled for any chosen time (given the minimum step size). For example, a 24 hour product can be allocated to any hour, for example to the next 24 hours (i.e. 6:00 to 6:00, etc').

Lemma 1: For given durations D, L flexible allocation products from total of N_{D} durations and total resource capacity Q, the allocation vector A(D,Ta) must support:

$$Q = {\sum }_{i = 1}^{L} {\sum }_{j = 0}^{{d}_{i}} {{a}^{i}}_{{T}_{a} - {d}_{i} + j} + {\sum }_{i = L}^{{N}_{D}} {{a}^{i}}_{{T}_{a} - {d}_{i}} \qquad [ 7 ]$$

Proof: At any specific moment Ta the provider needs to reserve enough capacity to support all products that are to be sold before the moment Ta and therefore are going to make use of resources at that moment. The first part of the equation deals with L flexible allocation products, while up to moment Ta there can be different allocations that were reserved at Ta-dᵢ, Ta-dᵢ+1, Ta-dᵢ+2, . . . , Ta moments (total dᵢ possible times). The second part of the equation deals with N_{D}-L fix allocation products that can be allocated at different moments Ta-dᵢ.

The question is how to find an allocation vector

$$A ( D , {T}_{a} ) = ( {{a}^{1}}_{{T}_{a}} , {{a}^{2}}_{{T}_{a}} , … {{a}^{{N}_{D}}}_{{T}_{D}} )$$

that reflects the market demand for a specific resource at time Ta. To solve this problem and find such an allocation vector we use an iterative mechanism that starts with best effort guessing and adjusts the vector based on feedback.

We assume that the provider guesses an allocation vector

$${A}^{0} ( D , {T}_{a} ) = ( {{a}^{1}}_{{T}_{a}}^{0} , {{a}^{2}}_{{T}_{a}}^{0} , … {{a}^{{N}_{D}}}_{{T}_{D}}^{0} )$$

that satisfies Eq. 7.

Now we define U(D,Tₐ)=(u₁,u₂, . . . u_{N}_{_{D}}) as the vector of total ordered resources, to be allocated at t=Ta, for different durations D=(d₁,d₂, . . . d_{N}_{_{D}}). We assume that we have stored a vector of total ordered resources within a database, for every resource R, every duration D and every possible allocation time Ta.

Now we define the nominal point EU*, where the average trade floor activity is to be handled. Then at the nominal point, the (uᵢ/aᵢ) ratio is given by:

$${( \frac{{u}_{i}}{{a}_{i}} )}^{*} = \frac{1}{E {U}_{2}} ln ( \frac{E {U}^{*} - E {U}_{0}}{E {U}_{1}} )$$

[8]

Since uᵢ represents actual orders collected at a specific trade floor, it reflects the market behavior regarding specific product duration at a specific time. It is well known that market behavior has oscillations over the periods of a day (24 hours), over the week (7 days) and sometimes even over the month (31 days). Therefore, it is possible to use the following feedback mechanism, to adjust the allocation vector to be closer to the normal pricing point:

The following feedback mechanism can adjust the allocation between the trade floors: for every duration dᵢ the allocation aᵢ is adjusted for Ta=same hour on the same day as follows:

if uᵢ/aᵢ<(uᵢ/aᵢ)* then aᵢ⁺=k₁aᵢ k₁<1

if uᵢ/aᵢ>(uᵢ/aᵢ)* then aᵢ⁺=k₂aᵢ k₂>1 [9]

In the first case the actual orders are smaller then the normal point, therefore it is reasonable to decrease the available resource for trade at similar times.

In the second case the actual orders are higher then the normal point, therefore it is reasonable to increase the available resource for trade at similar times.

Again, after finding the new allocation vector, we need to normalize it and solve the condition equation for the correct allocation.

Multi Domain Solution

Since service deployment may require more then one carrier being involved and time constraints (i.e. establishing new physical links), it is necessary to expand the bidding and asking procedures. Suppose player i wants to create a new link that involves purchasing using a few carriers, then he needs to define a plan

$$P {{L}^{i}}_{k}$$

where k=(1 . . . K) represents plan k out of K possible plans the carrier may have. A plan

$$P {{L}^{i}}_{k}$$

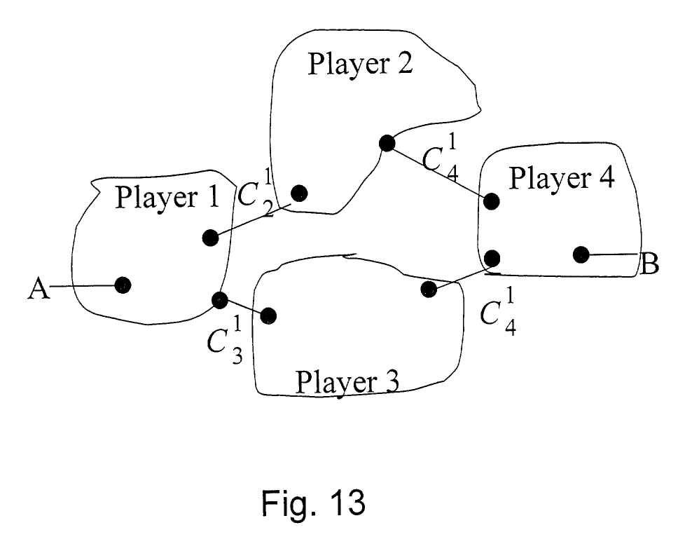

is a vector of all alternative chains of tasks Tⱼⁱ=(cⱼⁱ,tₛ,t_{E}), where j is a seller index that allocates capacity cⱼⁱ to support player i's service traffic at a time period starting at tₛ and ending at t_{E}. Reference is now made to FIG. 13, which is a simplified diagram showing typical network relationships for a carrier. FIG. 13 shows a number of players 1 . . . 4, and the network has two nodes A and B for present consideration. Let us say that player 1 wishes to build a route between ports A and B. He has two alternatives 1→2→4 and 1→3→4. Thus, we can write the plan vector as follow:

$$P {L}_{k \text{:} A \to B}^{i = 1} = [ \begin{matrix}{T}_{2}^{1} & {T}_{4}^{1} \\ {T}_{3}^{1} & {T}_{4}^{1}\end{matrix} ] \qquad ( 1 )$$

According to the above definition, player 1 may have relationships with all players, even with those he has no direct connection (i.e. player 4 in the example). This definition enables wider possibilities for inter-carrier relationship, allowing a carrier to have self-control and quality assurance. In addition it expands the market liquidity, since in a world where all players can buy and set their own direct links through a carrier they are not connected with, the ability to know and manage all players relationships becomes extremely complex to the point where a seller may prefer to have a known or published floor price for all potential buyers.

As is clear from the example, it is possible to have a situation where player 1 buys capacity c₄¹ from player 4, while entering from different edges. If all prices were elastic according to destinations in a carrier's network, then each route may in practice amount to the same c₄¹. However, to make it more general, it is preferable to include the attributes of each capacity c₄¹(2,B,BR,QoS) and c₄¹(3,B,BR,QoS), which means there are two T₄¹ tasks in the bidding process. That is to say, even if the prices on the two routes are the same, other attributes such as quality of service may not be.

Eqn. (1) above may now be written as:

$$P {L}_{k A \to B}^{i = 1} = [ \begin{matrix}{T}_{2}^{1} ( 1 , 4 , B R , Q o S , {t}_{s} , {t}_{e} ) & {T}_{4}^{1} ( 2 , 4 , B R , Q o S , {t}_{s} , {t}_{e} ) \\ {T}_{3}^{1} ( 1 , 4 , B R , Q o S , {t}_{s} , {t}_{e} ) & {T}_{4}^{1} ( 3 , 4 , B R , Q o S , {t}_{s} , {t}_{e} )\end{matrix} ] \qquad ( 2 )$$

Beside the capacity/resources market, there is the telecommunication services market. A capacity buyer is a services seller and vice versa. Therefore, it is always possible to say that both players are sellers and buyers, while market forces lead them to match.

The question for the buyer is through which carrier to route traffic. It should be borne in mind that the buyer actually is also a seller—albeit a traffic seller. Therefore the buyer's question may be modified to find the path that will maximize their expected utility. Such a path may be found by a searching programming. If we use an annealing (Gini technique)—or stochastic—technique then we can reduce the value changes and then find a semi-static solution. For such a process it is preferable to consider a different filter for each resource, since each resource has a different dynamic.

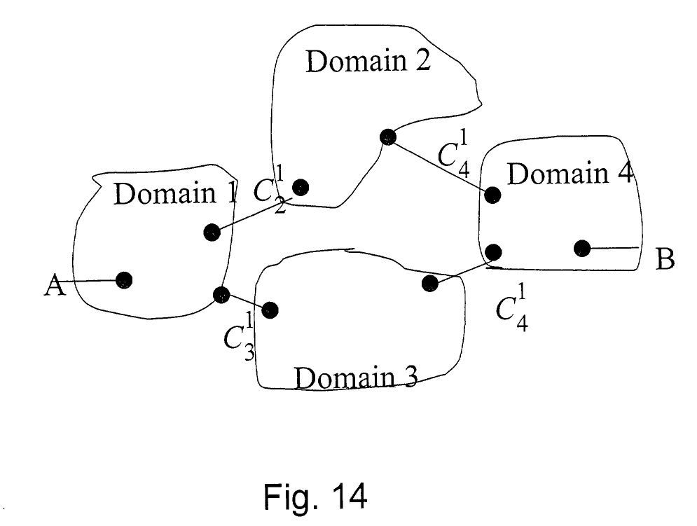

Reference is now made to FIG. 14, which shows a series of domains having inter-domain brokers arranged therebetween.

A further reason why the possible routes around the network is of interest is to avoid loops. As discussed above, loop avoidance is needed to prevent the same offer arriving several times at the same broker or even entering infinite loops, thus leading to confusion and network overload. A protocol is thus provided, specifically aimed at Inter-network brokers, to avoid such loops. The protocol is based on being able to identify specific offers and thus to be able to delete duplicate copies of the same bid. Identification of offers may, in the current embodiments, be via identification of the corresponding provider, or simply by applying a number to the offer, or a combination thereof.

It is noted that a loop avoidance mechanism, whilst a part of inter-domain trading, may also be provided as part of intra-domain trading, for example in domains in which there are multiple providers as well as multiple consumers, and the domain is set up such that loop formation is possible.

A preferred embodiment of the loop avoidance mechanism requires that each provider is assigned a provider ID. The ID is preferably unique at least to the domain. The combination of the ID with a domain ID is preferably unique for all associated domains.

In general, within a domain, an offer is generated by a provider's broker following a request from the provider, and is broadcast to each other broker in the domain. The offer is received by each other broker and processed, and a reply is sent to the originating broker. However, the inter domain broker works differently. If it receives an offer from within its domain, it broadcasts it to its twin inter domain broker, that is the inter domain broker of the other domain with which it works. If it receives an offer from outside its domain, it broadcasts the offer to each broker within its domain. An offer originating at A may reach B by several routes including direct routes and loops.

A first preferred embodiment operates at the level of the inter-domain brokers. Each provider adds its ID to any passing offer, so that the offer builds up a chain of Ids that identify the route it has taken. The broker simply avoids passing on any offer that already includes an ID number of the domain to which it is forwarding the offer.

The above embodiment avoids looping of offers although it will be noted that it does not prevent forwarding of offers that have followed entirely different routes. A further disadvantage of the above embodiment is that the provider ID numbers are made available to different domains. Information about commercial relationships could thus be compromised. Thus in a second preferred embodiment, the provider ID is replaced with a request number. Only the originating domain knows the relationship between the request number and the provider. The request number is preferably provided at the domain level so that there is a risk that two domains could inadvertently assign the same number. Such a risk may be minimized by making the numbers large so as to reduce the probability of identical numbers being selected. The broker simply checks the request number to ensure that it is not a number he has already passed on.

In a further embodiment the request ID may be supplied by an agreed party or 3^{rd} party server.

In the following, a listing of protocol commands is given for a trading protocol that allows bids and offers to be defined and supports inter-domain trading.

Main Protocol Commands

The inter-domain protocol as given below is based on TCP/IP, but may equally well operate with other like protocols that provide similar reliable interfaces. The inter-domain protocol includes three commands sets as follows:

1. Allocation commands set,

2. Miscellaneous commands set, and

3. Accounting commands set

In general each and every command is followed by an ACK message—OK, ERR and the like, and may have different types.

Allocation Commands Set

The following two commands can be generated by the customer, asking the provider to buy a product, or to sell a product:

Request_to_buy

| | |
|---|---|
| {Issuer ID | (optional) |
| Issuer ID list | (optional) |
| Request ID number | (mandatory) |
| Request IDs list | (mandatory) |
| Time of issuing | (mandatory) |

| | |
|---|---|
| Last time to receive BID | = 0 - open for ever |
| | = t minutes/hours before start time of allocation |
| | = Specific time |

| | | |
|---|---|---|
| Media type | = IP bandwidth | (mandatory) |
| | = ATM VC | |
| | = ... | |

Capacity

(for media type ATM VC it includes four attributes:

| | |
|---|---|
| ingress point, | (mandatory) |
| egress point, | (mandatory) |

| | |
|---|---|
| Bit Rate, | = 0 - open and the cost must be specified |
| | = #Number - the minimum required bit rate |

| | |
|---|---|
| QoS parameters | (optional) |

| | ) |
|---|---|
| Start time of allocation | = 0 - as soon as possible, i.e. now. |
| | = specific time |

(mandatory)

| | |
|---|---|
| End time of allocation | = the sum of Start time and Duration |
| | = specific time |
| Duration | = 0 - the minimum duration available (i.e. for the |
| | maximum rate available) |
| | = end time minus start time |
| | = lower then the difference between the end and the |
| | start times - to find the best deal between the times for |
| | the specified duration. |

(mandatory)

| | |
|---|---|
| Continue buy | = 0 - only once |
| | = Repetition time (every hour/day/week/...) |

(mandatory)

| | | |
|---|---|---|
| Price | (cost, | = 0 - open, |
| | | = #Number - the maximum cost the issuer willing to |
| | | pay. |

| | (mandatory) |
|---|---|
| Risk, | (optional) |

| | |
|---|---|
| Fee | = Percent |
| | = Constant |
| | = min/max between percents and constant |

(optional)

)

}

| | |
|---|---|
| {Issuer ID | (optional) |
| Issuer ID list | (optional) |
| Request ID number | (mandatory) |
| Request IDs list | (mandatory) |
| Time of issuing | (mandatory) |

| | |
|---|---|
| Last time to receive BID | = 0 - open for ever |
| | = t minutes/hours before start time of allocation |
| | = Specific time |

| | | |
|---|---|---|
| Media type | = IP bandwidth | (mandatory) |
| | = ATM VC | |
| | = ... | |

Capacity

(for media type ATM VC it includes four attributes:

| | | |
|---|---|---|
| ingress point, | (mandatory) | |
| | egress point, | (mandatory) |

| | |
|---|---|
| Bit Rate, | = #Number - the maximum bit rate to be |
| | provided |

QoS parameters

(optional)

)

| | |
|---|---|
| Start time of allocation | = 0 - as soon as possible, i.e. now. |
| | = specific time |

(mandatory)

| | |
|---|---|
| End time of allocation | = the sum of Start time and Duration |
| | = specific time |
| Duration | = end time minus start time |
| | = lower then the difference between the end and the |
| | start times - to find the best deal between the times for |
| | the specified duration. |

(mandatory)

| | |
|---|---|
| Continue sell | = 0 - only once |
| | = Repetition time (every hour/day/week/...) |

(mandatory)

| | | |
|---|---|---|
| Price | (cost, | = 0 - open, |
| | | = #Number - the minimum cost the issuer |
| | | willing to receive for the service he sells. |

| | (mandatory) |
|---|---|
| Risk, | (optional) |

| | |
|---|---|
| Fee | = Percent |
| | = Constant |
| | = min/max between percents and constant |

(optional)

)

}

The following two commands can be generated by the provider, answering the requester with a proposal to buy or to sell:

| | |
|---|---|
| {Bidder ID | (optional) |
| Request ID number | (mandatory) |
| Time of Bidding | (mandatory) |
| Bid expiration | = Open |
| | = t minutes that the bidder reserves the offer |
| | and wait for the requestor for an answer. |
| Capacity | |

(for media type ATM VC it includes four attributes:

| | |
|---|---|
| ingress point, | (mandatory) |
| egress point, | (mandatory) |
| Bit Rate, | (mandatory) |
| QoS parameters | (mandatory/optional) |

)

| | | |
|---|---|---|
| Start time of allocation | = 0 now. | |
| | = specific time | (mandatory) |
| End time of allocation | = specific time | (mandatory) |

| | |
|---|---|
| Duration | = end time minus start time |

| | | (optional) |
|---|---|---|
| Price | (cost, | (mandatory) |
| | Risk, | (optional) |

)

}

| | |
|---|---|
| {Bidder ID | (optional) |
| Request ID number | (mandatory) |
| Time of Bidding | (mandatory) |
| Bid expiration | = Open |
| | = t minutes that the bidder reserves the offer |
| | and wait for the requestor for an answer. |
| Capacity | |

(for media type ATM VC it includes four attributes:

| | |
|---|---|
| ingress point, | (mandatory) |
| egress point, | (mandatory) |
| Bit Rate, | (mandatory) |
| QoS parameters | (mandatory/optional) |

)

| | | |
|---|---|---|
| Start time of allocation | = 0 now. | |
| | = specific time | (mandatory) |
| End time of allocation | = specific time | (mandatory) |

| | |
|---|---|
| Duration | = end time minus start time |

| | | (optional) |
|---|---|---|
| Price | (cost, | (mandatory) |
| | Risk, | (optional) |

)

}

The following two commands can be generated by the customer, as a final answer who won or lost auction:

| | |
|---|---|
| {Issuer ID | (optional) |
| Request ID number | (mandatory) |

Capacity
(for media type ATM VC it includes four attributes:

| | |
|---|---|
| ingress point, | (optional) |
| egress point, | (optional) |
| Bit Rate, | (optional) |
| QoS parameters | (optional) |

)

| | | |
|---|---|---|
| Start time of allocation | = 0 now. | |
| | = specific time | (optional) |
| End time of allocation | = specific time | (optional) |

| | |
|---|---|
| Duration | = end time minus start time |

(optional)

| | | |
|---|---|---|
| Price | (cost, | (optional) |
| | Risk, | (optional) |

)

}

| | |
|---|---|
| {Issuer ID | (optional) |
| Request ID number | (mandatory) |
| Bid ID number | (optional) |

}

The following command can be generated by a player that wants to buy or to sell an option.

| | |
|---|---|
| {Issuer ID | (optional) |

| Issuer ID list | (optional) | |
|---|---|---|
| Request ID number | (mandatory) | |
| Request IDs list | (mandatory) | |
| Time of issuing | (mandatory) | |
| Option time of issuing | | (mandatory) |
| Request type | = to buy an option | |
| | = to sell an option | |
| | | (mandatory) |
| Option expiration date | | (mandatory) |
| Option type | = PUT or CALL | (mandatory) |

| | |
|---|---|
| Last time to receive BID | = 0 - open up to the expiration date |
| | = t minutes/hours before expiration date |
| | = Specific time |

| | | |
|---|---|---|
| Media type | = IP bandwidth | (mandatory) |
| | = ATM VC | |
| | = ... | |

Capacity

(for media type ATM VC it includes four attributes:

| ingress point, | | (mandatory) |
|---|---|---|
| egress point, | | (mandatory) |
| Bit Rate, | = #Number | (mandatory) |

| | |
|---|---|
| QoS parameters | (optional) |

)

| | |
|---|---|
| Start time of allocation | = 0 - at the expiration date. |
| | = Other specific time |

(mandatory)

| | |
|---|---|
| End time of allocation | = the sum of Start time and Duration |
| | = specific time |

(mandatory)

| | |
|---|---|
| Duration | = end time minus start time |
| | = lower then the difference between the end and the start times |
| | - to enable flexible option of finding the best deal at given |
| | time. |

(mandatory)

| | |
|---|---|
| Continue buy | = 0 - only once |
| | = Repetition time (every hour/day/week/...) |

(mandatory)

| | | |
|---|---|---|
| Price | (Option cost | (mandatory) |

| | |
|---|---|
| Media cost, | (mandatory) |

| | |
|---|---|
| Risk, | (optional) |

| | |
|---|---|
| Fee | = Percent |
| | = Constant |
| | = min/max between percents and constant |

(optional)

)

}

The following command can be generated by a player that wants to response to a request for buying or selling an option.

| | |
|---|---|
| {Bidder ID | (optional) |
| Request ID number | (mandatory) |
| Bid type | = to buy an option |
| | = to sell an option |
| | (optional) |
| Time of Bidding | (mandatory) |

| | |
|---|---|
| Option time of issuing | (optional) |

| | |
|---|---|
| Bid expiration | = Open |
| | = t minutes after bidding time |

| Option expiration date | | (optional) |
|---|---|---|
| Option type | = PUT or CALL | (optional) |
| Capacity | | |

(for media type ATM VC it includes four attributes:

| ingress point, | | (mandatory) |
|---|---|---|
| egress point, | | (mandatory) |
| Bit Rate, | = #Number | (mandatory) |

| | |
|---|---|
| QoS parameters | (optional) |

)

| | |
|---|---|
| Start time of allocation | = 0 - at the expiration date. |
| | = Other specific time |

(optional)

| | |
|---|---|
| End time of allocation | = the sum of Start time and Duration |
| | = specific time |

(optional)

| | |
|---|---|
| Duration | = end time minus start time |
| | = lower then the difference between the end and the start times |
| | - to enable flexible option of finding the best deal at given |
| | time. |

(optional)

| | |
|---|---|
| Continue buy | = 0 - only once |
| | = Repetition time (every hour/day/week/...) |

| | | (mandatory) |
|---|---|---|
| Price | (Option cost | (mandatory) |
| | Media cost, | (optional) |

| | |
|---|---|
| Risk, | (optional) |

| | |
|---|---|
| Fee | = Percent |
| | = Constant |
| | = min/max between percents and constant |

(optional)

)

}

The following two commands can be generated by the option seller that answer who won or lost the auction to buy/sell the option.

| {Issuer ID | (optional) | |
|---|---|---|
| Request ID number | (mandatory) | |
| Bid ID number | (optional) | |
| Bid type | = to buy an option | |
| | = to sell an option | |
| | (optional) | |
| Option expiration date | | (optional) |
| Option type | = PUT or CALL | (optional) |

Capacity

(for media type ATM VC it includes four attributes:

| | |
|---|---|
| ingress point, | (optional) |
| egress point, | (optional) |
| Bit Rate, | (optional) |
| QoS parameters | (optional) |

)

| Start time of allocation | = 0 now. | |
|---|---|---|
| | = specific time | (optional) |
| End time of allocation | = specific time | (optional) |

| | |
|---|---|
| Duration | = end time minus start time |

| | | |
|---|---|---|
| | (optional) | |
| Price | (cost, | (mandatory) |
| | Risk, | (optional) |
| ) | | |

}

| | |
|---|---|
| {Issuer ID | (optional) |
| Request ID number | (mandatory) |
| Bid ID number | (optional) |

}

The following command can be generated by the last option holder to signal the relevant provider to supply him with the capacity allocated in the option at the expiration date:

| | |
|---|---|
| {Issuer ID | (optional) |
| Bidder ID | (optional) |
| Request ID number | (mandatory) |
| } | |

Miscellaneous Commands Set

The following four commands are part of the basic interaction between the brokers, and allow new brokers to be setup, old brokers to be deleted, hereinafter “tear down”, and allowing working or updating of existing brokers:

During setup of a new broker or customer agent the newcomer identifies itself internally and externally, thus:

```
{Broker ID number
  Address (IP)
Provider ID number
  Served customer ID
  Setup time
  Other important information
}
```

For tear-down of a broker or a customer agent it must notify all brokers that are in contact with it, thus:

```
{Broker ID number
  Address (IP)
  Provider ID number
  Served customer ID
  Tear down time
  Reason for tearing down
  Replacer broker
  Other important information
}
```

Every x time period each broker sends a message that he is alive

```
{Broker ID number
  Address (IP)
  Provider ID number
  Served customer ID
  Other important information
}
```

If some of the configuration information was changed the broker need to update all brokers that are in contact with him, thus

```
{Broker ID number
  Address (IP)
  New information that was updated
}
```

Accounting Commands Set

The accounting commands set supports a variety of information parameters such as total BIDs received, total costs, total purchased capacity, etc.

There are two commands designed to be sufficiently flexible to cover the different parameters:

{specify the type of required information}

{provide the required information in ASCII format, or any other format}

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. A resource allocation platform for allocating resources between a provider and a plurality of users for a resource allocation price, the resources being duration dependent resources, the platform comprising:
an agent-based interaction mechanism for allowing said provider and said plurality of users to indicate required and surplus resources, and
a pricing engine, associated with said interaction mechanism, for ascertaining a resource allocation price.

2. The platform of claim 1, wherein the pricing engine comprises a learning mechanism for learning demand behavior of individual users, therefrom to provide said price.

3. The platform of claim 2, wherein said demand behavior is an observed demand price curve for a respective user.

4. The platform of claim 1, wherein said pricing engine further comprises a differentiation mechanism for altering said price by applying a user based differentiation policy to said price.

5. The platform of claim 2, wherein said learning mechanism is a per-user neural network.

6. The platform of claim 2, wherein said learning mechanism is a neural network assigned per a cluster of users.

7. The platform of claim 2, wherein said demand behavior is an observed demand price behavior for a respective user, said resources comprise a plurality of different products and wherein said observed demand price behavior comprises a curve per product, said learning mechanism being operable to prepare a separate price-demand curve for each product.

8. The platform of claim 1, wherein said resources are data communication capacity resources.

9. The platform of claim 8, wherein said resources are one of a group comprising bandwidth, duration, rate access, CPU access, trunk access, cache memory, quality of service, and combinations thereof.

10. The platform of claim 8, wherein said resources comprise a plurality of different products, each one of said products being defined by a respective duration and at least one of bandwidth, rate access, CPU access, trunk access, cache memory, and quality of service.

11. The platform of claim 1, further comprising an allocation engine associated with said pricing engine, said allocation engine being operable to allocate available resources using rules, according to availability and according to respective resource cost outputs of said pricing engine.

12. The platform of claim 11, wherein said allocation engine is operable to allocate resources into an allocation space.

13. The platform of claim 11, wherein said allocation engine is operable to allocate capacity by maximizing an overall utility along a time continuum, wherein utility components for future points along said time continuum are calculated by including terms for probabilities of bids occurring at respective ones of said future points.

14. The platform of claim 11, wherein said allocation engine is further operable to allocate said available resources in such a way as to maximize a predetermined utility function.

15. The platform of claim 14, wherein said allocation engine is further operable to use feedback information of achieved utilities to enhance maximization of said predetermined utility function.

16. The platform of claim 14, wherein said allocation engine is operable to carry out optimization of a mix within a group of products.

17. The platform of claim 16, wherein said optimization comprises measuring changes in utility over changes in allocation between said products, and to allocate capacity from products showing lower changes in utility to products showing higher changes in utility.

18. The platform of claim 1, wherein said agent-based interaction mechanism comprises a broker agent per user and a broker agent per provider.

19. The platform of claim 18, wherein said agent based interaction mechanism further comprises an inter-provider broker agent.

20. The platform of claim 1, wherein said agent-based interaction mechanism comprises broker agents for translating requests from respective users and providers into offers and bids, therewith to interact with other broker agents.

21. The platform of claim 1, wherein said resources are apportionable into products being portions of a total amount of said resources and wherein said price engine is operable to build in a risk cost factor to respective products, such that said cost factor is inversely related to a size of a respective portion.

22. The platform of claim 1, wherein said duration-based resources are apportionable into products having different time durations and wherein said price engine is operable to build in a risk cost factor to respective products such that said cost factor is inversely related to a size of a respective time duration.

23. The platform of claim 1, wherein said duration-based resources are apportionable into products having different bandwidths and wherein said price engine is operable to build in a risk cost factor to respective products such that said cost factor is inversely related to a size of a respective bandwidth.

24. The platform of claim 22, wherein said duration-based resources are apportionable into products having different bandwidths and wherein said price engine is operable to build in a risk cost factor to respective products such that said cost factor is inversely related to a size of a respective bandwidth.

25. A method of managing a time-dependent resource between at least one provider and a plurality of users, said method comprising:
assigning a broker agent to each provider and each user to translate requests concerning said resource into offers and bids,
using learned demand behavior of each user to assign a price to offers and bids concerning said user, and
allocating resources according to a predetermined utility function based at least partly on said assigned prices.

26. The method of claim 25, further comprising using further differential information of each user together with a provider pricing policy to arrive at said price.

27. An interface, for interfacing between resource allocation platforms, said resource allocation platforms being for allocating resources between a provider and a plurality of users for a resource allocation price, the resources being duration dependent resources, at least one of the platforms comprising:
an agent-based interaction mechanism for allowing said provider and said plurality of users to indicate required and surplus resources, and
a pricing engine, associated with said interaction mechanism, for ascertaining a resource allocation price,
the platforms interfacing with each other over junctions,
the interface comprising:
an agent for each platform at each junction, said agent being a part of a respective agent-based interaction mechanism, and further comprising an inter-platform protocol for exchanging resource allocation data with a corresponding agent of a respective interfacing platform, thereby to support inter-platform resource allocation across said junction.

28. The interface of claim 27, wherein said inter-platform protocol comprises a loop avoidance mechanism for preventing resource allocation data from looping between platforms.

29. The interface of claim 28, wherein said loop avoidance mechanism comprises assigning identification data to an instance of resource allocation data and wherein said protocol comprises making passing on said resource allocation data dependent upon a test of said identification data.

30. The interface of claim 29, wherein said identification data is a randomly generated number.

31. The interface of claim 30, wherein said randomly generated number is a relatively large number, thereby to reduce to negligible proportions the probability of two instances being assigned an identical number.
